(19) United States
(12) Patent Application Publication
(10) Pub. No.: US 2024/0420265 A1
(43) Pub. Date: Dec. 19, 2024

(54) SECURITY ECOSYSTEM, DEVICE AND METHOD FOR CONTROLLING WORKFLOWS ASSOCIATED WITH DIFFERENT ENTITIES BASED ON EXPORT AND IMPORT RULES

(71) Applicant: MOTOROLA SOLUTIONS, INC., Chicago, IL (US)

(72) Inventors: Robert MROWIEC, Liszki (PL); Vitaliy SMEYKO, Krakow (PL); Lukasz GROCHOLSKI, Mokrzyska (PL)

(21) Appl. No.: 18/209,839

(22) Filed: Jun. 14, 2023

(51) Int. Cl. G06Q 50/26; G08B 13/196; H04L 9/40

(52) U.S. Cl. CPC G06Q 50/265; G08B 13/1968; H04L 63/20

(57) ABSTRACT

A security ecosystem, device and method for controlling workflows associated with different entities based on export and import rules is provided. For example, a computing device monitors execution of a first safety workflow, associated with a first entity, comprising a first trigger and a first responsive action. The computing device compares an event, associated with the first trigger, with an export rule. In response to the event of the first safety workflow meeting the export rule, the computing device compares the event with an import rule, associated with a second entity, for initiating a second safety workflow based on the event and associated with the second entity. In response to the event meeting the import rule, the computing device initiates the second safety workflow associated with the second entity, the second safety workflow comprising a second trigger and a second responsive action, the second trigger corresponding to the event.

### BACKGROUND OF THE INVENTION

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

However, multiple security ecosystems and/or environments may be implemented for different entities. When a workflow associated with a first entity occurs, such a workflow may be associated with a real-world event that may have implications for a second entity. For example, a robbery at a first location associated with a first entity may be relevant to a second location associated with a second entity. Alternatively, to gather evidence for the robbery, and/or to track the robbers, it may be beneficial to engage physical devices associated with the second entity.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a security ecosystem capable of configuring and automating workflows, in accordance with some examples.

FIG. 2 depicts a security ecosystem capable of configuring and automating workflows, in accordance with some examples.

FIG. 3 depicts a security ecosystem capable of configuring and automating workflows, in accordance with some examples.

FIG. 5 depicts a security ecosystem capable of configuring and automating workflows, in accordance with some examples.

FIG. 4 depicts a security ecosystem capable of configuring and automating workflows, in accordance with some examples.

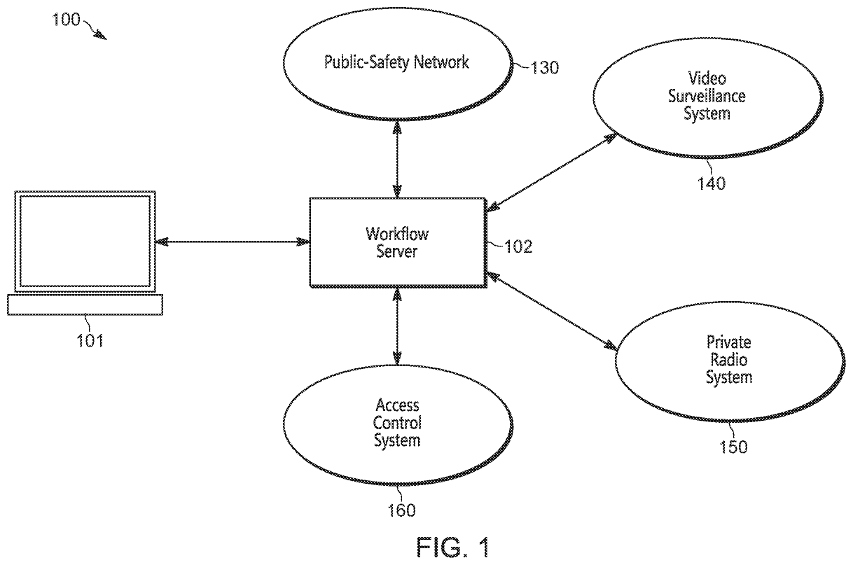

FIG. 6 is a block diagram of a workflow server of FIG. 1, in accordance with some examples.

FIG. 7 is a block diagram of a workstation of FIG. 1 utilized to generate a workflow, in accordance with some examples.

FIG. 8 depicts a dashboard for generating a workflow, in accordance with some examples.

FIG. 9 depicts the dashboard of FIG. 8 with an example workflow, in accordance with some examples.

FIG. 10 depicts the dashboard of FIG. 8 with other example workflows, in accordance with some examples.

FIG. 11 depicts the system of FIG. 1 adapted to implement a method for controlling workflows associated with different entities based on export and import rules, in accordance with some examples.

FIG. 12 depicts different buildings and/or locations, associated with different entities, for which associated workflows may be implemented, in accordance with some examples.

FIG. 13 is a block diagram of a workflow computing device and/or the workflow server of FIG. 6, showing functional blocks thereof, in accordance with some examples.

FIG. 14 depicts a flowchart of a method for controlling workflows associated with different entities based on export and import rules, in accordance with some examples.

FIG. 15 depicts the dashboard of FIG. 8 with example workflows associated with a first entity, in accordance with some examples.

FIG. 16 depicts a portion of the workflow computing device of FIG. 13 at least partially implementing aspects of a method for controlling workflows associated with different entities based on export and import rules, in accordance with some examples.

FIG. 17 depicts a portion of the workflow computing device of FIG. 13 at least partially implementing further aspects of a method for controlling workflows associated with different entities based on export and import rules, in accordance with some examples.

FIG. 18 depicts a portion of the workflow computing device of FIG. 13 at least partially implementing yet further aspects of a method for controlling workflows associated with different entities based on export and import rules, in accordance with some examples.

FIG. 19 depicts a dashboard with example workflows associated with a second entity, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing workflows across multiple differing systems and devices is provided herein. During operation, a computing device, such as a workflow server, may monitor one or more triggers that occur in the differing systems and devices based on sensor data generated by, and received from one or more sensors, and, in response, implement one or more actions that may include communicating with one or more communication devices across the differing systems and devices, for example to dispatch security personnel associated with the one or more communication devices to locations at which the sensor data was collected that led to the triggers.

Hence, provided herein is a computing device, for example in the form a workflow server, and/or a workflow computing device, interacting with a workstation, which monitors execution of a safety workflow and/or a plurality of safety workflows. A safety workflow is understood to include an association between a trigger, which occurs when certain conditions are met as determined using sensor data from a physical sensor, and an action, which occurs in response to the trigger and which may include at least an electronic interaction and/or communication with a communication device. One example trigger may comprise determining that a given door is open (e.g., and/or has been open for a given time period) and a responsive action may comprise communicating with a given communication device to dispatch security personnel operating the communication device to the location of the open door.

In particular examples, the computing device provided herein may be configured to execute safety workflows associated with a plurality of entities and correspondingly interact with workstations for such entities. Furthermore, while such safety workflows may be executed independent of one another, such that triggers of safety workflows associated with a first entity do not trigger actions of safety workflows associated with a second entity, real-world events associated with triggers of safety workflows associated with the first entity may be relevant to the second entity. However, it may be challenging to determine which of such real-world events may be relevant. Hence, provided herein is a security ecosystem, device and method for controlling workflows associated with different entities based on export and import rules.

A first aspect of the specification provides a method comprising: monitoring, at a workflow computing device, execution of a first safety workflow associated with a first entity, the first safety workflow comprising a first trigger and a first responsive action executed by a first physical device associated with the first entity; comparing, at the workflow computing device, an event, associated with the first trigger of the first safety workflow, with an export rule, associated with the first entity, for exporting the event to one or more second safety workflows associated with one or more second entities different from the first entity; in response to the event of the first safety workflow meeting the export rule, comparing the event with an import rule, associated with a second entity for initiating a second safety workflow associated with the second entity, the second safety workflow based on the event; and, in response to the event meeting the import rule, initiating the second safety workflow associated with the second entity, the second safety workflow comprising a second trigger and a second responsive action executed by a second physical device associated with the second entity, the second trigger corresponding to the event. Each of the above-mentioned aspects will be discussed in more detail below, starting with example system and device architectures of the system in which the embodiments may be practiced, followed by an illustration of processing blocks for achieving an improved security ecosystem, device and method for controlling workflows associated with different entities based on export and import rules.

A second aspect of the specification provides a computing device comprising: a processor; and a computer-readable storage medium having stored thereon program instructions that, when executed by the processor, cause the computing device to perform a set of operations comprising: monitoring execution of a first safety workflow associated with a first entity, the first safety workflow comprising a first trigger and a first responsive action executed by a first physical device associated with the first entity; comparing an event, associated with the first trigger of the first safety workflow, with an export rule, associated with the first entity, for exporting the event to one or more second safety workflows associated with one or more second entities different from the first entity; in response to the event of the first safety workflow meeting the export rule, comparing the event with an import rule, associated with a second entity for initiating a second safety workflow associated with the second entity, the second safety workflow based on the event; and, in response to the event meeting the import rule, initiating the second safety workflow associated with the second entity, the second safety workflow comprising a second trigger and a second responsive action executed by a second physical device associated with the second entity, the second trigger corresponding to the event.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

Turning now to the drawings, wherein like numerals designate like components, FIG. 1 illustrates a security ecosystem 100 capable of configuring and automating workflows across multiple systems. The security ecosystem 100 is interchangeably referred to hereafter as the system 100. Furthermore, workflows as referred to herein may alternatively be referred as security workflows as workflows as referred to herein may be used to implement security-based action and/or security base processes.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private radio system 150, and an access control system 160. A workflow server 102 is coupled to each of the network 130 and the systems 140, 150, and 160. The workstation 101 is shown coupled to the workflow server 102, and is utilized to configure the workflow server 102 with workflows, for example as generated by a user. It should be noted that although the components in FIG. 1 are shown geographically separated, these components can exist within a same geographic area, such as, but not limited to a school, a hospital, an airport, a sporting event, a stadium, a factory, a warehouse and/or any other suitable location and/or building and the like. It should also be noted that although only the network 130 and the systems 140, 150, and 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution™'s Orchestrate™ and Ally™ dispatch and incident management software or any other suitable workflow management and/or incident management software. As will be discussed in more detail below, the workstation 101 is configured to present a user with a plurality of triggers capable of being detected by the network 130 and the systems 140, 150, and 160 as well as present the user with a plurality of actions capable of being executed by the network 130 and the systems 140, 150, and 160. The user will be able to generate workflows and upload these workflows to the workflow server 102 based on the presented triggers and actions. While only one workstation 101, the system 100 may comprise a plurality of workstations 101.

The workflow server 102 may comprise a server running Motorola Solution™'s Command Central™ software suite comprising the Orchestrate™ platform. While the workflow server 102 is depicted as one device, the workflow server 102 may be implemented as one or more computing devices, one or more servers, one or more cloud computing devices, and the like, and/or the functionality of the workflow server 102 may be geographically distributed.

The workflow server 102 is configured to receive workflows generated by the workstation 101 (and/or a plurality of workstations 101) and implement the workflows. Furthermore, the workflow server 102 may implement (e.g., concurrently, and the like) different workflows associated with different workstations. Particularly, the workflows are implemented by analyzing events detected by the network 130 and the systems 140, 150, and 160 and executing appropriate triggers. In a particular example, a user may generate a workflow on the workstation 101 that has a trigger comprising the video surveillance system 140 detecting a loitering event, and has an action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 comprises includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field-of-views over time. The video surveillance system 140 is configured with a recognition engine/video analysis engine (VAE) that comprises a software engine that analyzes any video captured by the cameras using, for example, any suitable process which may include, but is not limited to machine learning algorithms, convolutional neural networks (CNNs), and the like. Using the VAE, the video surveillance system 140 is capable of “watching” video to detect any triggers and report the detected triggers to the workflow server 102. These triggers may include, but are not limited to, appearance searches and unusual Activity Detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution™'s Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IoT) network which may serve to connect every-day devices to the Internet. Devices such as cars, kitchen appliances, medical devices, sensors, doors, windows, HVAC (heating, ventilation, and air conditioning) systems, drones, . . . , etc. can all be connected through the IoT network of the access control system 160. Indeed, any suitable device that can be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to generate rule-based, automated workflows between technologies to enhance efficiency, and improve response times, effectiveness, and overall safety. The security ecosystem 100 generally has the capability to detect triggers across a number of devices within the network 130 and the systems 140, 150, and 160 and quickly take actions by automatically executing the proper procedure (i.e., executing the appropriate action once a trigger is detected).

The network 130 and the systems 140, 150, and 160 are next described in further detail.

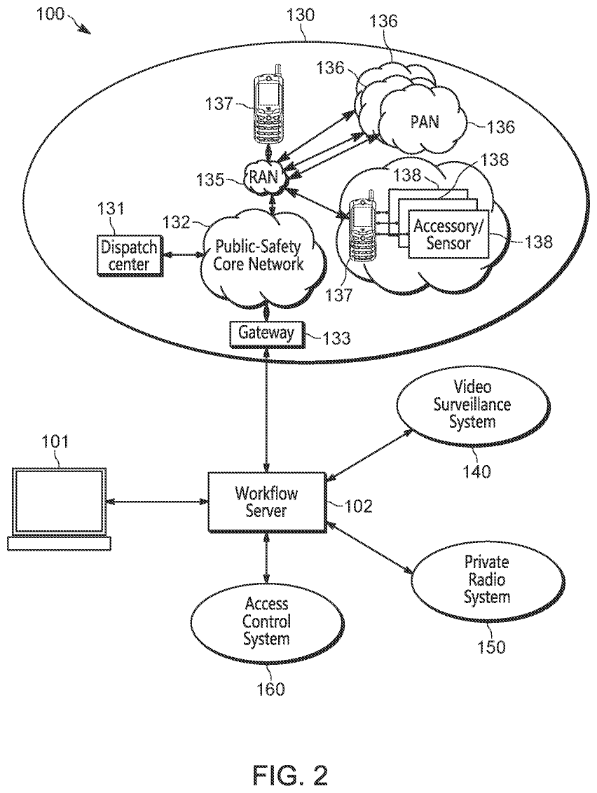

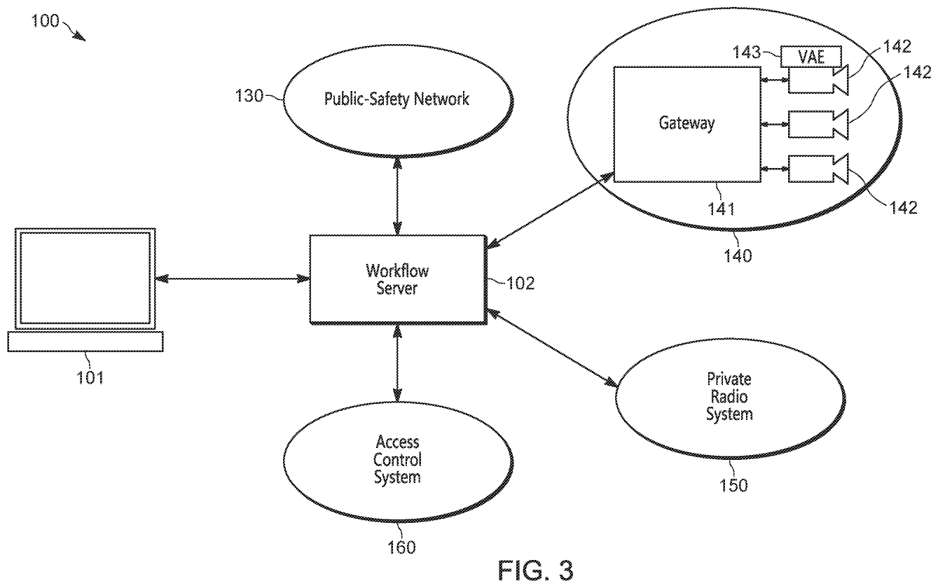

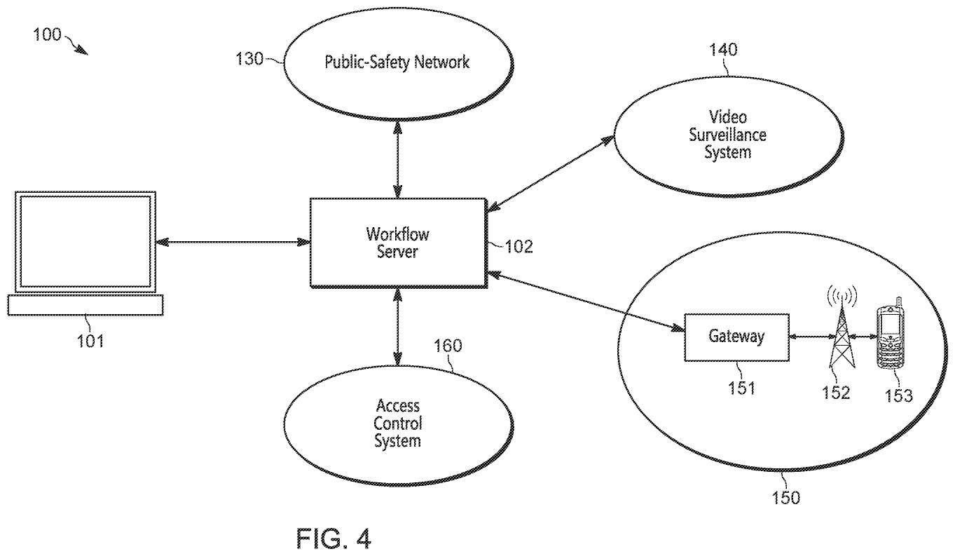

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least one radio 137, such as a public-safety radio and the like (however the radios 137 may include, but are not limited to, any suitable combination of communication devices, such as mobile phones, two-way radios, and the like). As shown, each PAN 136 comprises a radio 137 acting as a hub to smart devices/accessories/sensor 138 (interchangeably referred to hereafter as the sensors and/or a sensor 138).

The gateway 133 may comprise an Avigilon™ Control Center running Avigilon's Access Control Management software (e.g., when the public-safety network 130 includes video cameras and/or the radios 137 include video cameras). The gateway 133 is configured to run any suitable Application Program Interface (API) to provide communications between the public-safety core network 132 and the workflow server 102.

A public-safety officer (not shown in FIG. 2) may be equipped with sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g., in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control over which accessories are allowed to connect to each other when forming a PAN 136. Once bonded, accessories then can establish a connection without user intervention. A bond may be generated through a process called “pairing”. The pairing process may be triggered by a specific request by the user to generate a bond from a user via a user interface on the accessories. Thus, as shown, public-safety network 130 incorporates PANs 136 generated as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VoIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) c based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensor 138 via a local communication link. The radios 137 may be configured to determine when to forward information received from PA sensors 138 to, for example, a dispatch center or the workflow server 102.

Some examples of sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137 which may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to a radio 137 which may forward the information to dispatch center 131 and/or the workflow server 102.

In some examples, a sensor 138 may comprise a heart rate sensor that uses electrical contacts with the skin to monitor an electrocardiography (EKG) signal of its wearer, or may use infrared light and imaging device to optically detect a pulse rate of its wearer, among other possibilities. This information may be reported to a radio 137 which may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137 which may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public-safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of image sensors and/or cameras 142 and a gateway 141.

Cameras 142 may be fixed or mobile, and may have pan/tilt/zoom (PTZ) capabilities to change their field-of-view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The VAE 143 is generally configured to “watch” video and detect pre-selected objects such as license plates, people, faces, automobiles. The VAE 143 may also be configured to detect certain actions of individuals, such as fighting, loitering, crimes being committed, . . . , etc. and/or actions of objects, such as speeding, a car driving on a pedestrian walkway, a car moving against the flow of traffic, . . . , etc.; however the VAE 143 may be configured to detect any suitable action. The VAE 143 may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires. Combinations of object detectors may be utilized to detect combinations of objects, such as automobiles on fire, and the like, automobiles that are not on fire, and the like.

The gateway 141 may comprise an Avigilon™ Control Center running Avigilon's Access Control Management software. The gateway 141 is configured to run any suitable Application Program Interface (API) to provide communications between any cameras 142 and the workflow server 102.

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one radio 153. Communications from the radio 153 to the workflow server 102 passes through the system infrastructure 152, the gateway 151, and ultimately to the workflow server 102.

The gateway 151 may comprise an Avigilon™ Control Center running Avigilon's Access Control Management software (e.g., when the private radio system 150 and/or the radios 153 include video cameras). The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solution™'s MOTOTRBO™ equipment, such as an SLR Series Repeater (e.g., SLR 1000, SLR 5000, or SLR8000 repeater) configured to provide two-way radio service to radio 153. However, the system infrastructure 152 may comprise one or more of a base station and/or base station controller and/or repeater.

Although only a single radio 153 is shown in FIG. 4, any suitable number of radios 153 may be present within the private radio system 150. Each radio 153 may comprise a MOTOTRBO™ two-way radio (such as a Motorola Solution™ XPR 5000 Series radio) with digital technology providing integrated voice and data communication.

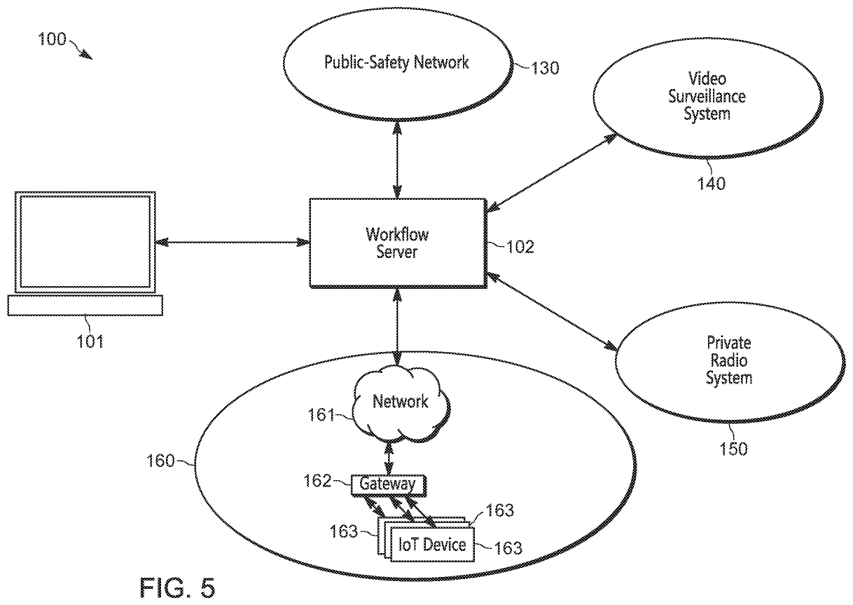

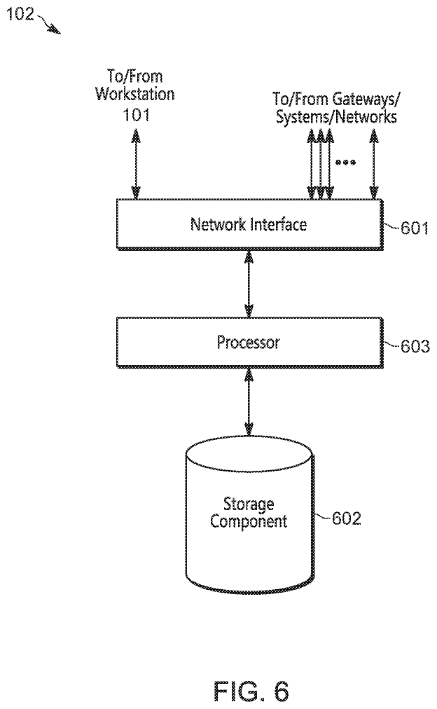

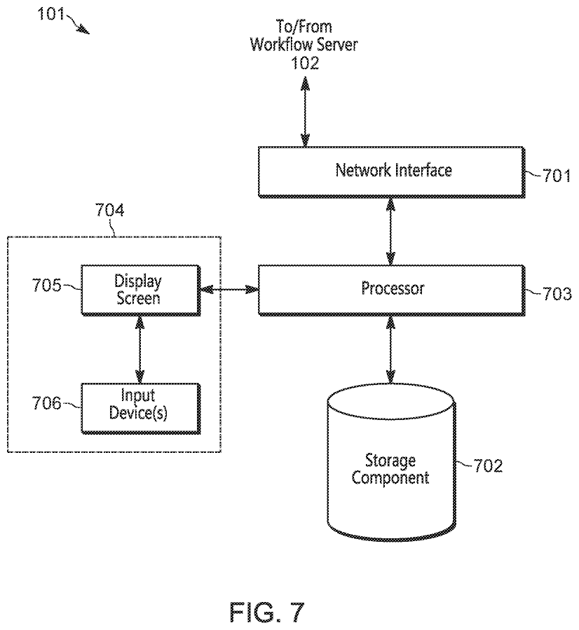

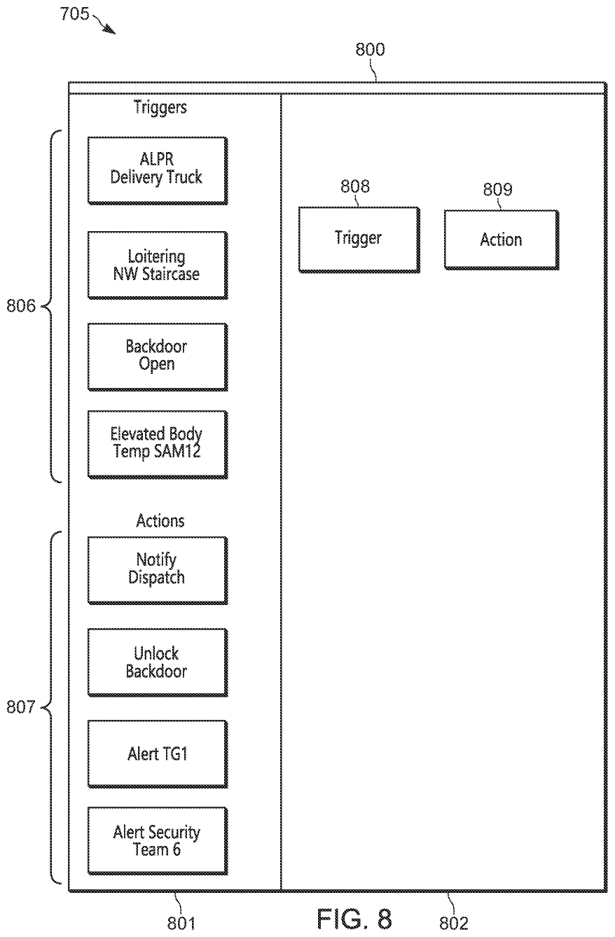

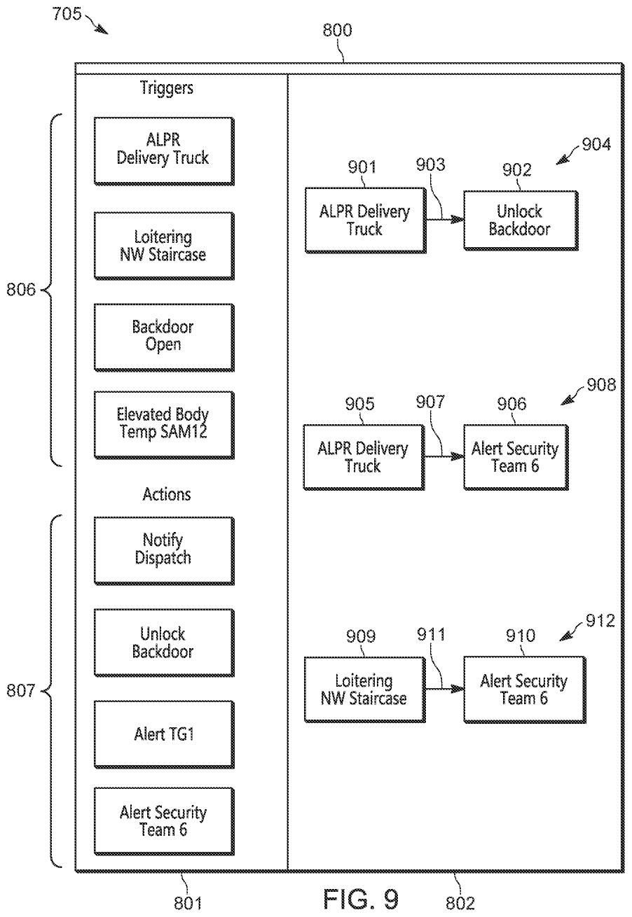

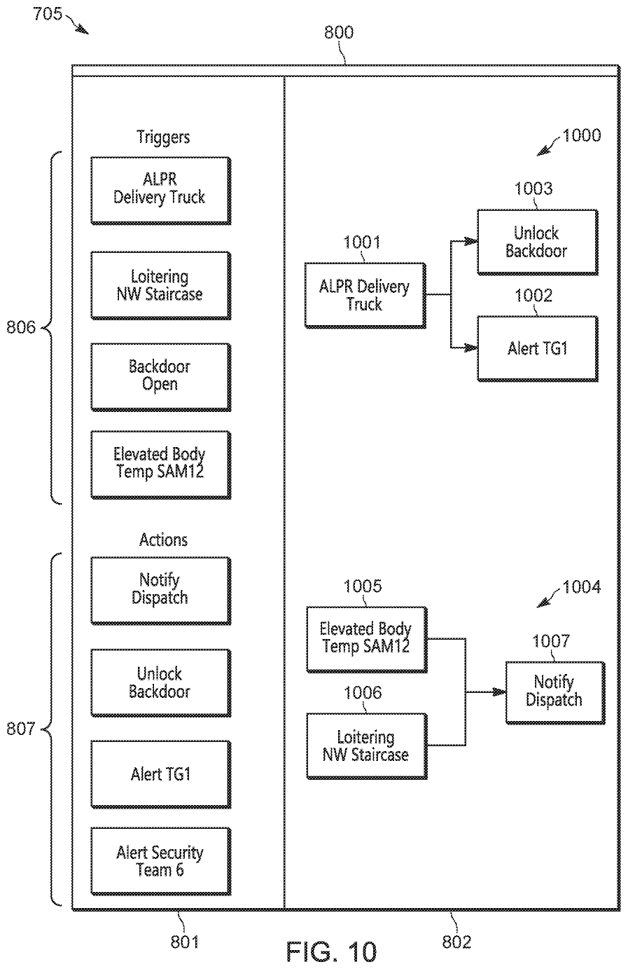

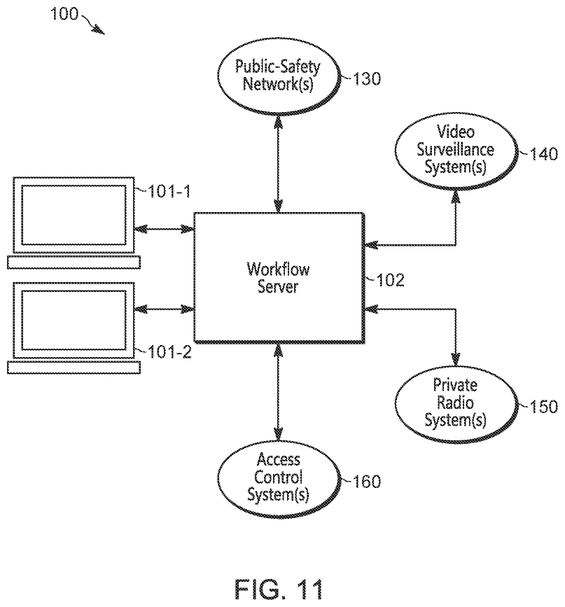

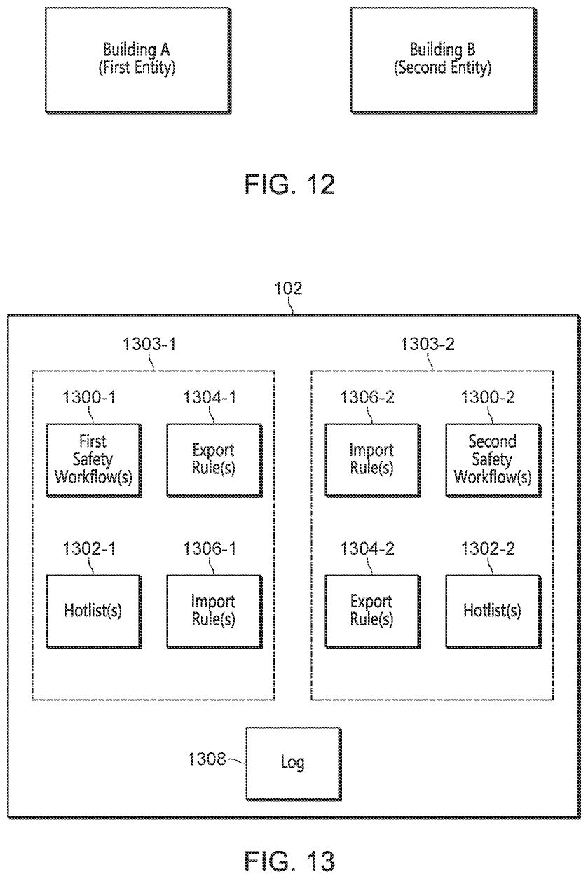

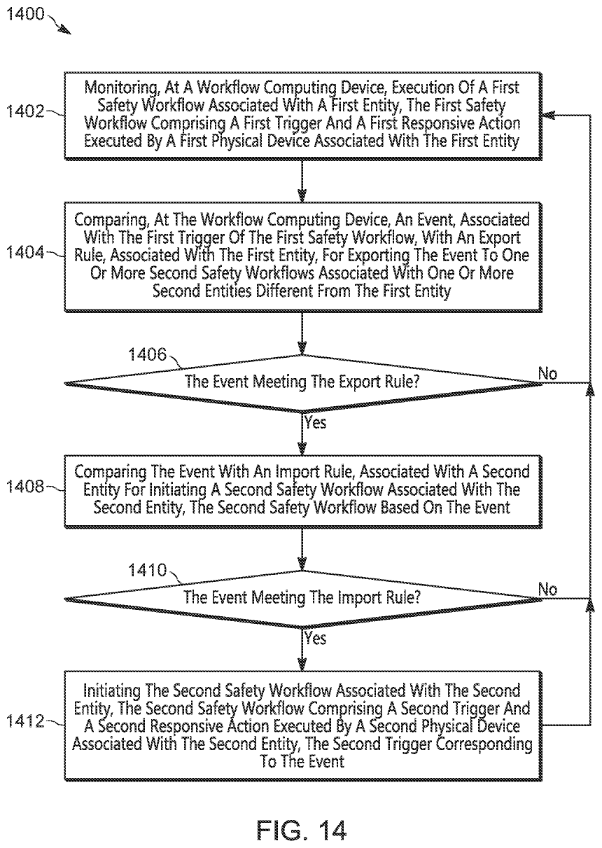

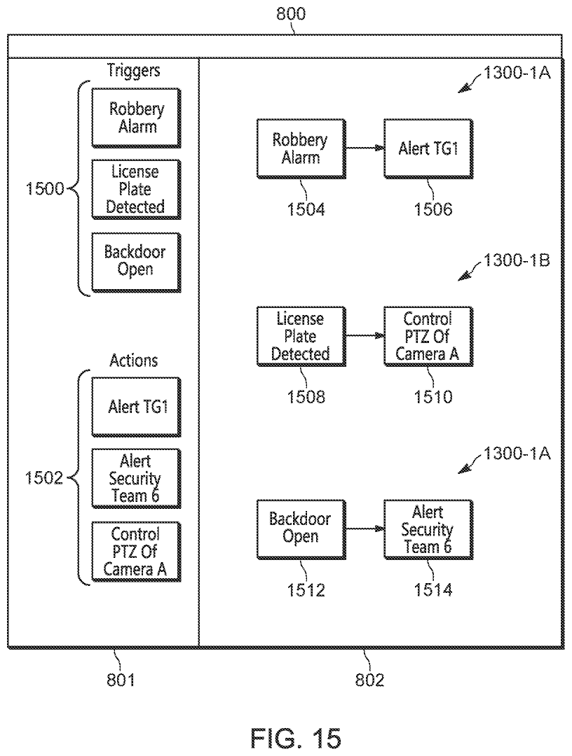

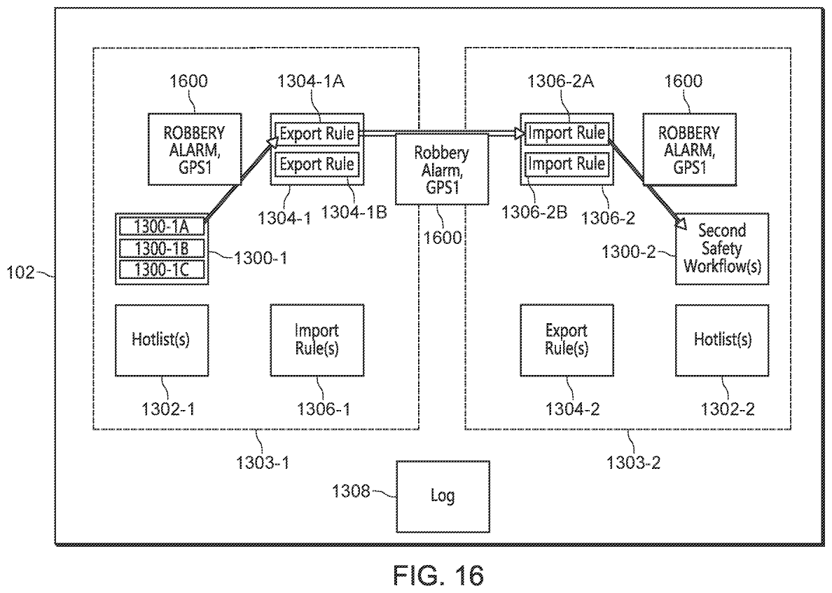

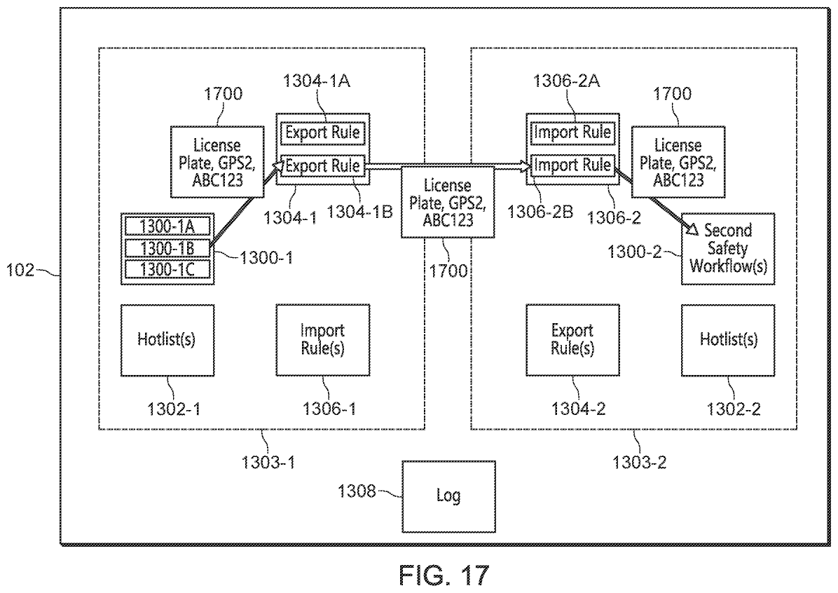

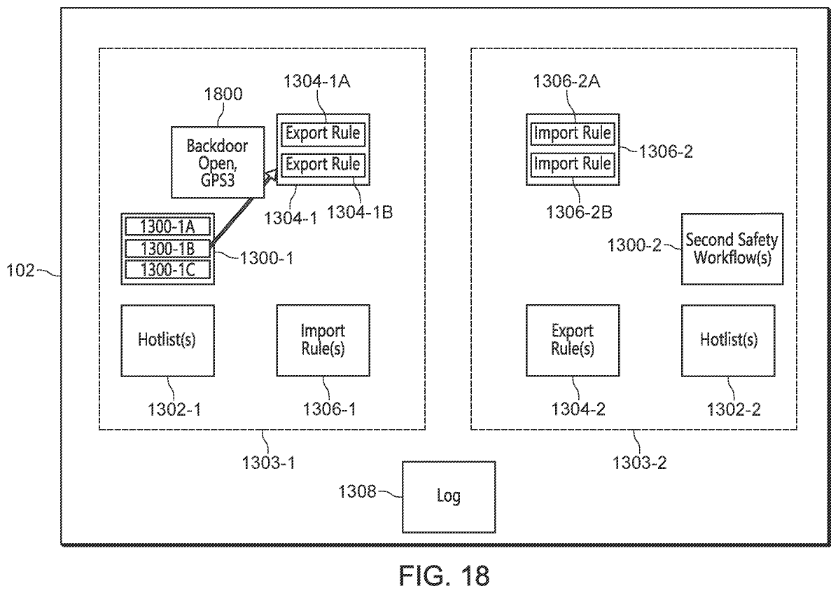

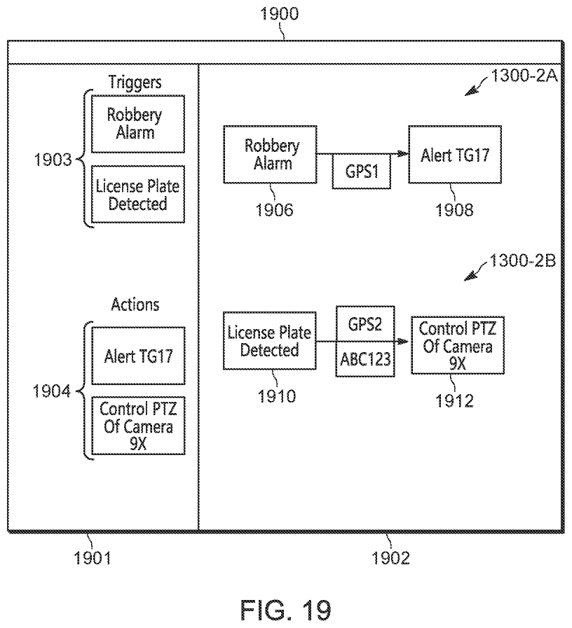

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise devices that control objects, doors, windows, sensors, and the like. Any particular suitable communication protocol (e.g., an IoT protocol) may be used for each IoT device. For example, various proprietary protocols such as DNP, Various IEC**** protocols (IEC 61850 etc., . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PoIP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

FIG. 6 is a block diagram of the workflow server 102 of FIG. 1. As shown, the workflow server 102 comprises a network interface 601, a storage component 602 (e.g., as depicted a database, but may comprise any suitable memory and/or storage component), and a processor 603. The processor 603 is understood to include any suitable logic circuitry.

The network interface 601 includes any suitable components for communicating with other suitable components of the system 100, in particular, as depicted, to the workstation 101, the gateways 133, 141, 151, 162 of the network 130 and the systems 140, 150, and 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces, T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g., of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may execute an instruction set/software (e.g., Motorola Solution™'s Command Central™ software suite comprising the Orchestrate™ platform) which may be stored at the storage component 602.

The storage component 602 may comprise standard memory (such as Random Access Memory (RAM), Read Only Memory (ROM), and the like) and generally serves to store associations between triggers and actions. Examples of various triggers and actions are illustrated in in Table 1, below.

TABLE 1
Associations Between Triggers and Actions.

| Trigger | Action |
|---|---|
| Warehouse back door opened | Pan camera “342” to point at door |
| Man-Down sensor activated | Notify dispatch center via |
| for Officer Smith | emergency text message |
| ALPR for delivery truck | Open back gate |
| . . etc. | . . . etc. |

Indeed, it is generally understood that the workflow server 102 comprises the processor 603 and a computer-readable storage medium, for example, as depicted in the form of the storage component 602, having stored thereon program instructions (e.g. as represented by safety workflows described herein and/or the triggers and actions thereof) that, when executed by the processor 602, cause the workflow server 102 to perform a set of operations, for example corresponding to safety workflows and/or the triggers and actions thereof.

FIG. 7 is a block diagram of the workstation 101 of FIG. 1 utilized to generate a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution™'s Orchestrate™ and Ally™ dispatch and incident management software which may be stored at the storage component 702. The execution of such software may allow users of the GUI 704 to generate workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution™'s Orchestrate™ and Ally™ dispatch and incident management software may be stored at the storage component 702.

The GUI 704 generally provides a man/machine interface for receiving an input from a user and displaying information. For example, the GUI 704 may provide a mechanism of conveying (e.g., displaying) user-generated workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g., a keyboard and mouse combination).

Indeed, it is generally understood that the workstation 101 comprises the processor 703 and a computer-readable storage medium, for example, as depicted in the form of the storage component 702, having stored thereon program instructions that, when executed by the processor 602, cause the workstation 101 to perform a set of operations, for example implementing the functionality of the workstation 101 as next described.

FIG. 8 illustrates the generation of a workflow. More particularly, FIG. 8 illustrates a dashboard 800 rendered at the display screen 705 utilized for the generation of workflows. As depicted, the dashboard 800 consists of the following main components:
a selection panel 801 (e.g., on a left-hand side), which lists available triggers 806 and actions 807;
a workspace 802, which comprises a large area in the middle of the dashboard 800 used to generate workflows that define the connections between triggers and actions. Each workflow in the workspace is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable various sensors, software, and devices within the security ecosystem 100, including, but not limited to, the radios 137, 153.

After a workflow is deployed (i.e., uploaded to the workflow server 102), its actions activate when the triggers occur. Triggers and actions appear on the workspace after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace (as described below) will generate a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow generation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as a trigger node, and an action 807 may be referred to as an action node. In order to associate the trigger 806 with the action 807, they are connected. To connect a trigger node to an action node, a user may click an end of the trigger node (e.g., that is closest to the action node) and drag a line to the action node, or vice versa. However, any suitable process for connecting nodes is within the scope of the present specification.

As shown in FIG. 9, which depicts the dashboard 800 in use, a trigger “ALPR Delivery Truck” 901 has been associated with an action “Unlock Backdoor” 902 by dragging a line 903 between the two, thereby forming a workflow 904. While only one trigger 901 and one action 902 is depicted in the workflow 904, the workflow 904 may comprise any suitable number of triggers (e.g., a trigger group) and any suitable numbers of associated action (e.g., an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g., the trigger 901), an associated backdoor (e.g., of a warehouse) is opened; such a backdoor may also comprise one of the IoT devices 163. While note depicted, a memory in the system 100 may also store a list of license plates for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate readers, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger 806 for detecting loitering at a particular “North West” (e.g., NW) staircase of a particular building (e.g., “Loitering NW Staircase”) that may be detected using a VAE 143 of one or more cameras 142 and the like. The triggers 806 further includes a trigger 806 for detecting whether a particular backdoor is open (e.g., “Backdoor Open”) that may be detected using a VAE 143 of one or more cameras 142 and/or an open/closed sensor on the backdoor and the like. The triggers 806 further includes a trigger 806 for detecting whether a particular individual, for example a first responder and/or police officer and/or security guard having an identifier “SAM12” has an elevated body temperature (e.g., “Elevated Body Temp SAM12”) that may be detected using a biometric sensor of one or more sensors 138 and the like.

For example, as depicted the actions 807 include an action 807 for notifying a first responder and/or police and/or security dispatch (e.g., “Notify Dispatch”) such as the dispatch center 131. The actions 807 further includes an action 807 for alerting a particular talkgroup identified by the identifier TG1 and/or Talkgroup #1 (e.g., “Alert TG1”) such as a particular talkgroup of the radios 137 (and/or the radios 153). The actions 807 further includes an action 807 for alerting a particular security team identified by the identifier Security Team 6 (e.g., “Alert Security Team 6”) which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

For example, as also shown in FIG. 9, the trigger “ALPR Delivery Truck” 806 may be added to the workspace 802 a second time from the selection panel 801, as a trigger “ALPR Delivery Truck” 905, and associated with a different action “Alert Security Team 6” 906 (e.g., added as an action 807 from the selection panel 801) by dragging a line 907 between the two, thereby forming a workflow 908. Such an example illustrates that a given trigger 806 may be used more than once to generate a workflow 904, 908, in association with different actions 807. Similarly, a given action 807 may be used more than once in the workspace 802 to form workflows with different triggers 806.

Similarly, as also shown in FIG. 9, the trigger “Loitering NW Staircase” 806 may be added to the workspace 802 from the selection panel 801, as a trigger “Loitering NW Staircase” 909, and associated with action “Alert Security Team 6” 910 (e.g., added as an action 807 from the selection panel 801) by dragging a line 911 between the two, thereby forming a workflow 912. Such an example illustrates that a given action 807 may be used more than once to generate a workflow 908, 912, in association with different triggers 806.

As illustrated in FIG. 10, a single trigger may be associated with multiple actions in a workflow. Thus, in an illustrated workflow 1000, a trigger 1001 of “ALPR Delivery Truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g., above a threshold body temperature”, or when loitering is detected in the NW staircase.

As mentioned above, it may be challenging to communicate to the one or more communication devices the sensor data that lead to the one or more triggers and/or to change and/or control the safety workflows.

In order to address such a problem, the workflow server 102 may be adapted to: monitor execution of a safety workflow, the safety workflow comprising one or more triggers and one or more responsive actions; provide, at a display screen, an indication of the safety workflow and respective visual indications of: a physical sensor that generated sensor data of a trigger of the safety workflow; and a communication device associated with a responsive action to the trigger; detect, via an input device, an interaction with one or more of the respective visual indications to interact with one or more of the physical sensor and the communication device; and based on the interaction, one or more of: retrieve the sensor data; initiate communication with the communication device; and send the sensor data to the communication device.

Hereafter, workflows may be interchangeably referred to as safety workflows as it is understood that workflows as described herein may be used to implement procedures and/or processes related to safety and/or public safety of persons and/or personnel, for example at a school, a hospital, an airport, a sporting event, a stadium, a factory, a warehouse and/or any other suitable location and/or building and the like. Hereafter, the workflow server 102 may be interchangeably referred to as a computing device (e.g., which may be implemented as one or more computing devices, one or more servers, one or more cloud computing devices, and the like). Hereafter, it is understood that any of the sensors 138, cameras 142, and IoT devices 163 comprise physical sensors that may generate sensor data that may be provided to the workflow server 102 to determine whether a trigger has occurred.

However, the system 100 and safety workflows provided herein may be further adapted to include other features.

For example, attention is next directed to FIG. 11 which depicts the system 100 adapted to include a first workstation 101-1 and a second workstation 101-2 respectively associated with a first entity and a second entity. The first workstation 101-1 and a second workstation 101-2 are interchangeably referred to hereafter, collectively, as the workstations 101, and, generically, as a workstation 101. This convention will be used elsewhere in the present specification. The workstations 101 are understood to be similar to the workstation 101 depicted in FIG. 1 and herein the first workstation 101-1 is understood to comprise the workstation 101 of FIG. 1. Hence, the first workstation 101-1 may access the dashboard 800 as described herein.

It is understood that the workflow server 102 is generally managing, executing and/or monitoring respective workflows associated with the first entity and the second entity. For example, the first workstation 101-1 may be operated as described herein with respect to the workstation 101 of FIG. 1, and may be used to configure the workflow server 102 with workflows associated with the first entity. Similarly, the second workstation 101-1 may be operated as described herein with respect to the workstation 101 of FIG. 1, and may be used to configure the workflow server 102 with workflows associated with the second entity.

As depicted in FIG. 11, the video surveillance system 140 may comprise one or more video surveillance systems 140, which may be shared between different entities, or may comprise respective video surveillance systems 140 associated with different entities. As such, as compared with the one video surveillance system 140 of FIG. 1, one or more video surveillance system(s) 140 are depicted in FIG. 11.

Similarly, as depicted in FIG. 11, the private radio system 150 may comprise one or more private radio systems 150, which may be shared between different entities, or may comprise respective private radio systems 150 associated with different entities. As such, as compared with the one private radio system 150 of FIG. 1, one or more private radio system(s) 150 are depicted in FIG. 11.

Similarly, as depicted in FIG. 11, the access control system 160 may comprise one or more access control systems 160, which may be shared between different entities, or may comprise respective access control systems 160 associated with different entities. As such, as compared with the one access control system 160 of FIG. 1, one or more access control system(s) 160 are depicted in FIG. 11.

Indeed, the notation “system(s)” in FIG. 11 is used for simplicity to indicate that the systems 140, 150, 160 may comprise respective pluralities of systems associated with different entities.

Similarly, as depicted in FIG. 11, the public-safety network 130 may comprise one or more public-safety networks 130, which may be service different entities, or may comprise public-safety networks 130 associated with different entities. As such, as compared with the one public-safety network 130 of FIG. 1, one or more public-safety network(s) 130 are depicted in FIG. 11. Indeed, the notation “network(s)” in FIG. 11 is used for simplicity to indicate that the one or more public-safety network(s) 130 may comprise respective pluralities of networks associated with different entities. For example, entities may be associated with same regions, or different regions, serviced by a same public-safety entity (e.g., a police entry, fire department, etc.), or serviced by different public-safety entities.

Attention is next directed to FIG. 12 which depicts two buildings, Building A and Building B, respectively managed by a first entity and a second entity. It is understood that Building A and Building B may be local to each other, or remote from each other. It is further understood that Building A and Building B may have respective video surveillance systems 140 deployed and/or installed internally and/or externally, respective private radio systems 150 deployed and/or installed internally and/or externally, and/or respective access control systems 160 deployed and/or installed internally and/or externally. Furthermore, Building A and Building B may be in a same public-safety jurisdiction, or in different public-safety jurisdictions and hence respective systems 140, 150, 160 thereof may be configured to operate in conjunction with a same public-safety network 130, or different public-safety networks 130.

It is understood that the workflow server 102 may be managing workflows for the first entity and the second entity using the systems 140, 150, 160 implemented in association with Building A and Building B, as well as the public-safety network(s) 130.

For example, attention is next directed to FIG. 13 which schematically depicts the workflow server 102 implementing different components and/or processes to implement functionality thereof. While the network interface 601, the storage component 602 and the processor 603 of FIG. 6 are not depicted, they are nonetheless understood to be present. It is understood in FIG. 13 that the network interface 601 is adapted to communicate with the first workstation 101-1 and the second workstation 101-2, the storage component 602 is understood to store files and/or instructions corresponding to the depicted components and/or processes, and the processor 603 is adapted to process such files and/or implement such instructions, as is next described.

As depicted, the workflow server 102 implements one or more first safety workflows 1300-1 associated with the first entity, which may be configured using the first workstation 101-1. Similarly, the workflow server 102 implements one or more second safety workflows 1300-2 associated with the second entity, which may be configured using the second workstation 101-2. The workflows 1300-1, 1300-2 are referred to interchangeably as the workflows 1300 and/or a workflow 1300.

As depicted, the workflow server 102 may have access to, and/or may maintain one or more first hotlists 1302-1 which may be used in given triggers of the one or more first safety workflows 1300-1. Similarly, the workflow server 102 may have access to, and/or may maintain one or more second hotlists 1302-2 which may be used in given triggers of the one or more second safety workflows 1300-2. The hotlists 1302-1, 1302-2 are referred to interchangeably as the hotlists 1302 and/or a hotlist 1302.

A hotlist 1302 may comprise, for example, a list of license plate numbers that may be searched for using video analytics in the system 100 and used in associated triggers of workflows 1300. For example, a trigger of a workflow 1300 may comprise “LICENSE PLATE DETECTED”, and the like, such that when an ALPR detects any license plate number in a hotlist 1302 a respective action of the workflow 1300 is implemented.

Similarly, a hotlist 1302 may comprise machine learning classifiers, vectors, and the like, that represent facial features, and the like, of suspects that may be searched for using video analytics in the system 100 and used in associated triggers of workflows 1300. For example, a trigger of a workflow 1300 may comprise “FACE DETECTED”, and the like, such that when a VAE 143, and the like, detects any suspect represented by a classifier, vector, and the like, in a hotlist 1302 a respective action of the workflow 1300 is implemented.

Similarly, a hotlist 1302 may comprise machine learning classifiers, and the like, that represent different types of weapons, such as guns, and the like, that may be searched for using video analytics in the system 100 and used in associated triggers of workflows 1300. For example, a trigger of a workflow 1300 may comprise “WEAPON DETECTED” and the like, such that when a VAE 143, and the like, detects any weapon represented by a classifier, vector, and the like, in a hotlist 1302 a respective action of the workflow 1300 is implemented.

However, a hotlist 1302 may comprise any suitable data that may be used in a trigger of a workflow 1300 to search for any corresponding item and/or person and/or action, and the like.

Furthermore, a hotlist 1302 may be particular to a given entity and/or may be shared amongst entities. Put another way, the hotlists 1302 may be the same or different.

Furthermore, a hotlist 1302 may be maintained by a respective entity and/or by a public-safety entity, and the like, maintaining the one or more public-safety network(s) 130. Furthermore, a hotlist 1302 may be stored and/or maintained at the dispatch center 131, and/or at any component of the one or more public-safety network(s) 130, and the like, and retrieved by the workflow server 102.

As depicted, the workflow server 102 implements respective workflow environments 1303-1, 1303-2 (e.g., workflow environments 1303 and/or a workflow environment 1303). The workflow environments 1303 may represent different security ecosystems implemented by the workflow server 102. While the workflow environments 1303 are represented as being separate from each other, such separation may be logical, and hence the processor 603 may be implementing both workflow environments 1303.

In particular, the one or more first safety workflows 1300-1 and the one or more hotlists 1302-1 are implemented in the first workflow environment 1303-1 associated with the first entity, and the one or more second safety workflows 1300-2 and the one or more hotlists 1302-2 are implemented in the second workflow environment 1303-2 associated with the second entity.

In general, workflow environments 1303 may be implemented independent of one another, for example for privacy reasons, to ensure no data overflow between the workflows 1300, and the like. Hence, when a trigger occurs in a workflow 1300 in one workflow environment 1303, actions of the workflow 1300 occur only in that one workflow environment 1303 and not in the other workflow environment 1303, and vice versa.

However, there are scenarios where a real-world event represented by a trigger of a first safety workflow 1300-1, in the first workflow environment 1303-1 associated with the first entity, may have relevancy to the second entity. In particular, while the workflow server 102 generally implements the workflow environments 1303 independent of each other, for certain real-world events associated with a first safety workflow 1300-1, a second safety workflow 1300-2 may be initiated, as described herein. Such initiation may furthermore occur in an opposite direction: for certain real-world events associated with a second safety workflow 1300-2, a first safety workflow 1300-1 may be initiated.

Hereafter, for clarity, the term “event” and/or “events” are understood to comprise data representing a real-world event that may have initiated a workflow 1300.

To facilitate event sharing, the workflow server 102 maintains first export rules 1304-1, associated with the first entity, in the first workflow environment 1303-1, and further maintains second export rules 1304-2, associated with the second entity, in the second workflow environment 1303-2. The first export rules 1304-1 may comprise rules for exporting events (e.g., event data) associated with the first entity to a second safety workflow 1300-2, and the second export rules 1304-2 may comprise rules for exporting events associated with the second entity to a first safety workflow 1300-1. The first export rules 1304-1 and the second export rules 1304-2 may be referred to as the export rules 1304 and/or an export rule 1304.

Similarly, as depicted, the workflow server 102 maintains first import rules 1306-1, associated with the first entity, in the first workflow environment 1303-1, and further maintains second import rules 1306-2, associated with the second entity, in the second workflow environment 1303-2. The first import rules 1306-1 may comprise rules for importing events associated with the second entity to a first safety workflow 1300-1, and the second import rules 1306-2 may comprise rules for importing events associated with the first entity to a second safety workflow 1300-2. The first import rules 1306-1 and the second import rules 1306-2 may be referred to as the import rules 1306 and/or an import rule 1306.

Hence, for example, the export rules 1304 may generally comprise filters for exporting certain events between the workflow environments 1303 and/or the workflows 1300, and the import rules 1306 may generally comprise filters for importing certain events between the workflow environments 1303 and/or the workflows 1300.

Furthermore, the export rules 1304 and/or the import rules 1306 may be generated and/or edited, and the like, using a respective workstation 101.

For example, an export rule 1304 may be to export given types of events (e.g., associated with given types of triggers of a safety workflow 1300) from one workflow environment 1303 to another workflow environment 1303. For example, one export rule 1304 may comprise “IF FIRE ALARM OCCURS, THEN EXPORT EVENT”, while another export rule 1304 may comprise “IF ROBBERY ALARM, THEN EXPORT EVENT”, while yet another export rule 1304 may comprise “IF LICENSE PLATE DETECTION, THEN EXPORT EVENT”, and the like. Hence, types of events that are exported may be controlled.

Conversely, an import rule 1306 may be to import given types of events from one workflow environment 1303 to another workflow environment 1303. For example, one import rule 1306 may comprise “IF FIRE ALARM RECEIVED, THEN IMPORT EVENT”, another import rule 1306 may comprise “IF ROBBERY ALARM RECEIVED, THEN IMPORT EVENT”, while another import rule 1306 may comprise “IF LICENSE PLATE DETECTED RECEIVED, THEN IMPORT EVENT”, and the like. Hence, types of events that are imported may be controlled.

As such, types of events that are exported, and types of events that are imported, may be controlled via the rules 1304, 1306.

Furthermore, when an event does not meet an export rule 1304, such an event may not be exported and/or when no export rule 1304 exists for an event, such an event may not be exported. Similarly, when an event does not meet an import rule 1306, such an event may not be imported and/or when no import rule 1306 exists for an event, such an event may not be imported.

Furthermore, in some examples, as depicted in FIG. 13, the workflow server 102 may maintain a log 1308 of when an event meets one or more of an export rule 1304 and an import rule 1306.

While the system 100 of FIG. 11, and the workflows 1300, etc., has been described with respect to two entities, it is understood that the system 100 may be adapted for any suitable number of entities, such that the workflow server 102 may implement any suitable numbers of respective workflows 1300 in any suitable number of respective workflow environments 1303, and maintain any suitable number of respective export rules 1304 and respective import rules 1306.

Hence, in a given workflow environment 1303, when an event associated with a trigger of a safety workflow 1300 occurs, and the event meets a respective export rule 1304, the workflow server 102 may export the event to the other workflow environments 1303, and/or all the other workflow environments 1303 being implemented by the workflow server 102. Similarly, when the event meets a respective export rule 1304, the workflow server 102 may compare the event to the respective import rules 1306 of the other workflow environments 1303, and/or all the other workflow environments 1303, being implemented by the workflow server 102. When the event meets a respective import rule 1306 of another workflow environment 1303, a respective safety workflow 1300 may be initiated.

However, in some examples, some workflow environments 1303 may be subscribed to participating in event sharing, while other workflow environments may not be subscribed to participating in event sharing, and the workflow server 102 may manage such subscriptions such that events are shared only amongst workflow environments 1303 that have subscribed to event sharing.

Attention is now directed to FIG. 14, which depicts a flowchart representative of a method 1400 for controlling workflows associated with different entities based on export and import rules. The operations of the method 1400 of FIG. 14 correspond to machine readable instructions that are executed by the workflow server 102, and specifically the processor 603. In the illustrated example, the instructions are represented by the blocks of FIG. 14 and may be stored at the storage component 602. The method 1400 of FIG. 14 is one way that the processor 603 and/or the workflow server 102 and/or the system 100 may be configured. Furthermore, the following discussion of the method 1400 of FIG. 14 will lead to a further understanding of the system 100, and its various components.

The method 1400 of FIG. 14 need not be performed in the exact sequence as shown and likewise various blocks may be performed in parallel rather than in sequence. Accordingly, the elements of method 1400 are referred to herein as “blocks” rather than “steps.” The method 1400 of FIG. 14 may be implemented on variations of the system 100 of FIG. 1, as well.

Furthermore, hereafter, the workflow server 102 is interchangeably referred to as a workflow computing device 102, for example as the workflow server 102 may comprise any suitable combination of one or more computing devices and/or one or more servers, one or more cloud computing devices, and the like. Put another way, the workflow server 102 may comprise any suitable computing device and is not particularly limited to a server.

Furthermore, it is understood that the workflow computing device 102 comprises: the processor 602; and a computer-readable storage medium, as represented by the storage component 603, having stored thereon program instructions (as represented by the blocks of FIG. 14) that, when executed by the processor 602, cause the workflow computing device 102 to perform a set of operations corresponding to the method 1400.

Furthermore, the method 1400 will be described with respect to a first safety workflow 1300-1 being implemented, the export rules 1304-1, and the import rules 1306-2, such that an events associated with a first safety workflow 1300-1 may initiate a second safety workflow 1300-2. However, it is understood that the method 1400 may be implemented with respect to a second safety workflow 1300-1 being implemented, the export rules 1304-2, and the import rules 1306-1, such that an events associated with a second safety workflow 1300-2 may initiate a first safety workflow 1300-1.

At a block 1402, the processor 603, and/or the workflow computing device 102, monitors execution of a first safety workflow 1300-1 associated with a first entity, the first safety workflow 1300-1 comprising a first trigger and a first responsive action executed by a first physical device associated with the first entity.

An example of such a first safety workflow 1300-1, including a first trigger and a first responsive action executed by a first physical device associated with the first entity is described with respect to FIG. 15. Furthermore, such physical devices may comprise one or more radios 137, 153, and the like, associated with the first entity, and/or one or more transceivers (e.g., of the network interface 601) used to contact the one or more radios 137, 153 associated with the first entity, and/or one or more of the IoT devices 163, and the like, associated with the first entity, as has been previously described.

At a block 1404, the processor 603, and/or the workflow computing device 102, compares an event (e.g., event data), associated with the first trigger of the first safety workflow 1300-1, with an export rule 1304-1, associated with the first entity, for exporting the event to one or more second safety workflows 1300-2 associated with one or more second entities different from the first entity.

In particular, such an event may be associated with one or more respective keywords, and, optionally, one or more respective locations, and the like. In particular, the event may be provided as any suitable data, in any format suitable for comparison with an export rule 1304 and/or an import rule 1306. In some examples the event may be provided in form of text of the first trigger. Furthermore, certain keywords may be provided in metadata of the event, such as keywords that define a crime (e.g., such as “Robbery”), a weapon, or another noun and/or verb from the text of the trigger.

Similarly, metadata of an event may include one or more respective locations associated with the event, for example associated with a place where the event occurred. Such one or more respective locations may be provided as Global Positioning System (GPS) coordinates, and the like, of a building (e.g., the Building A of FIG. 12), geofence coordinates (e.g., that may define a region within which the Building A is located), and the like. Herein, any location that is provided in a format that enables the location to be specifically identified (e.g. one set of GPS coordinates, an address of a building, and the like), may be referred to as an exact location. Furthermore, herein, any location that is provided in a format that defines an area within which a location is located, but may not identify an exact location (e.g. geofence data, a plurality of sets of GPS coordinates, an identifier of one or more blocks of a city, and the like), may be referred to as a coarse location.

Rules specifying whether an exact location (e.g., GPS coordinates, and the like), a coarse location (e.g., geofence coordinates, and the like), or no location is included in metadata of the event that is exported, may be configurable within the first safety workflow 1300-1, for example in the dashboard 800 for generating a workflow, and the like. When geofence coordinates, and the like, are used, the dashboard 800 may be configured with any suitable electronic options, menu systems, and the like, for selecting such geofence coordinates, including, but not limited to, specifying a diameter (and/or a radius, and the like) of a circular geofence and/or specifying a geofence of any suitable shape.

Alternatively, and/or in addition, rules specifying whether an exact location, a coarse location, or no location is included in metadata of the event that is exported, may be configurable within the first workflow environment 1303-1, for example in an export rule 1304-1 as described below. For example, a first safety workflow 1300-1 may be configured to include an exact location of event in metadata, and the like, but a corresponding export rule 1304-1 may cause the exact location to be changed to a coarse location, or vice versa, and/or a corresponding export rule 1304-1 may indicate that no location to be exported.

Furthermore, while certain information is described as being included in metadata associated with an event, such information may be included at any suitable portion of data representing the event, and in any suitable format, and/or as metadata, and/or in a body of data representing the event. Hence, keywords and/or locations, and the like, may be included in a body of data representing the event and/or in metadata of the data representing the event.

At a block 1406, the processor 603, and/or the workflow computing device 102 determines whether the event of the first safety workflow 1300-1 meets an export rule 1304-1.

For example, an export rule 1304-1 may comprise one or more keywords which may be compared to one or more keywords of the event. Furthermore, the one or more keywords may be provided in a body of an export rule 1304-1 and/or in metadata of an export rule 1304-1 and/or in any suitable portion of an export rule 1304-1.

As described above, an export rule 1304-1 may comprise a conditional rule, for example in the form of an “IF/THEN” statement, and the like.

Furthermore, whether an exact location, a coarse location, or no location is included in data of the event that is to be exported, may be indicated by an export rule 1304-1. For example, one export rule 1304-1 may comprise “IF FIRE ALARM OCCURS, THEN EXPORT EVENT AND EXACT LOCATION”. Another export rule event 1304-1 may comprise “IF ROBBERY ALARM OCCURS, THEN EXPORT EVENT WITH 1 KM GEOFENCE COORDINATES” (e.g., a circular geofence of a 1 KM diameter with the exact location being at the center of the geofence). Yet another export rule 1304 may comprise “IF LICENSE PLATE DETECTED, THEN EXPORT EVENT WITHOUT LOCATION”.

Furthermore, as has already been described, such export rules 1304-1 may change a location of an event to be exported from an exact location to a coarse location, or vice versa, or remove a location from an event.

However, an export rule 1304-1 may be provided in any suitable format and may comprise one or more keywords without strictly incorporating such one or more keywords into an “IF/THEN” statement and the like. For example, export rules 1304-1 may be provided in tables and/or in a database format that recite respective keywords and, alternatively, whether an exact location, a coarse location, or no location is to be exported.

In some examples, a location (e.g., an exact location) associated with the event may be exported as a default when an export rule 1304 does not otherwise specify whether or not a location is to be exported.

In response to the event of the first safety workflow 1300-1 meeting the export rule 1304-1 (e.g., a “YES” decision at the block 1406), at a block 1408, the processor 603, and/or the workflow computing device 102 compares the event with an import rule 1306-2, associated with a second entity for initiating a second safety workflow 1300-2 associated with the second entity, the second safety workflow 1300-2 based on the event.

For example, the export rule 1304-1 may comprise one or more keywords (e.g., incorporated into an “IF/THEN” statement and/or in any other suitable format), and the event meeting the export rule 1304-1 may comprise: one or more respective keywords, associated with the event, meeting one or more of the keywords of the export rule 1304-1.

Hence, for example, when an event includes one or more keywords such as “ROBBERY” and/or “ROBBERY ALARM”, and the export rule 1304-1 comprises “IF ROBBERY ALARM OCCURS, THEN EXPORT EVENT”, the event may meet the export rule 1304-1, for example as the keyword “ROBBERY” of the event is the same as the keyword “ROBBERY” of the export rule 1304-1, and/or the keywords “ROBBERY ALARM” of the event is the same as the keywords “ROBBERY ALARM” of the export rule 1304-1.

Similarly, when an event includes one or more keywords such as “LICENSE PLATE” and/or “LICENSE PLATE DETECTED”, and the export rule 1304-1 comprises “IF LICENSE PLATE DETECTED OCCURS, THEN EXPORT EVENT”, the event may meet the export rule 1304-1, for example as the keywords “LICENSE PLATE” of the event is the same as the keywords “LICENSE PLATE” of the export rule 1304-1, and/or the keywords “LICENSE PLATE DETECTED” of the event is the same as the keywords “LICENSE PLATE DETECTED” of the export rule 1304-2.

It is further understood that an event may include other types of data, including, but not limited to, information from the hotlist 1302-1 which may be used by a trigger of the first safety workflow 1300-1 to cause an action of the first safety workflow 1300-1. For example, such data may include a detected license plate number, a classifier used to detect an item (e.g., a weapon and/or a suspect), a vector used to detect a face (e.g., of a suspect), personally identifiable information (PII) associated with a suspect whose face was detected, an image of a detected item and/or face, and the like. Such data may be incorporated into metadata of the event, and/or in any suitable portion of the event, and exported with the event.

Furthermore, PII associated with a suspect may be retrieved from a database of suspects maintained by the public-safety network 130, and the like. For example, the hotlist 1302-1 may include images and/or vectors and/or classifiers associated with suspects, as well as PII associated with a suspect, as populated from suspect databases (not depicted) maintained at the public-safety network 130, and the like.

In some examples, however, an export rule 1304-1 may prevent certain data from being exported; for example, an export rule 1304-1 may prevent PII from being exported, and/or any other suitable information, such as an exact location (though a coarse location may be exported in such examples). However, exporting of any suitable data may be prevented by an export rule. In particular, an export rule 1304-1 may specify “DO NOT EXPORT NAME OF SUSPECT”, and the like, which may prevent a name of a suspect from being exported.

In yet further examples, an export rule 1304-1 may further specify that consent for exporting of any suitable data be obtained prior to exporting. Such consent may be obtained from an operator of the first workstation 101-1, for example, by providing at a display screen of the workstation 101-1 a query such as “EXPORT EVENT” along with information identifying the event to be exported, and electronic buttons, such as “YES” and “NO buttons; in this example, when a “YES” button is selected, and the like, the event is exported and the method 1400 continues to the next block; and, conversely, when a “NO” button is selected, and the like, the event is not exported and the method 1400 may end. In particular, an export rule 1304-1 may indicate that “CONSENT” is to be requested, and presence of the term “CONSENT” and the like at an export rule 1304-1 may cause the aforementioned query to be provided at a display screen of the workstation 101-1.

In yet further examples, an export rule 1304-1 may indicate that consent to export particular information, such as PII, and the like, is to be requested. In particular, an export rule 1304-1 may indicate that “CONSENT FOR PII” is to be requested, and presence of the term “CONSENT FOR PII” and the like at an export rule 1304-1 may cause a query for such consent to be provided at a display screen of the workstation 101-1. Using the example of PII, such consent may be obtained from an operator of the first workstation 101-1, for example, by providing at a display screen of the workstation 101-1 a query such as “EXPORT PII” along with the PII to be exported, and electronic buttons, such as “YES” and “NO buttons; in this example, when a “YES” button is selected, and the like, the event is exported with the PII and, conversely, when a “NO” button is selected, and the like, the event is exported without the PII, and the method 1400 continues to the next block in either instance.

At a block 1410, the processor 603, and/or the workflow computing device 102 determines whether the event of the first safety workflow 1300-1 meets the import rule 1306-2.

For example, an import rule 1306-2 may comprise one or more keywords which may be compared to one or more keywords of the event. Furthermore, the one or more keywords may be provided in a body of an import rule 1306-2 and/or in metadata of an import rule 1306-2 and/or in any suitable portion of an import rule 1306-2. Similarly, an import rule 1306-2 may comprise location criteria to which one or more locations of the event may be compared. Furthermore, the one or more keywords and/or the location criteria may be provided in a body of an import rule 1306-2 and/or in metadata of an import rule 1306-2 and/or in any suitable portion of an import rule 1306-2.

As described above, an import rule 1306-2 may comprise a conditional rule, for example in the form of an “IF/THEN” statement, and the like.

Furthermore, an import rule 1306-2 may further include location criteria which may be relative to a location associated with the second entity, the second workflow environment 1303-2, and/or the import rules 1306-2, such as a location of the Building B (e.g., in GPS coordinates, and the like). For example, one import rule 1306-2 may comprise “IF FIRE ALARM RECEIVED AND EVENT IS WITHIN 200 METERS, THEN IMPORT EVENT”. Another import rule event 1306-2 may comprise “IF ROBBERY ALARM RECEIVED AND EVENT IS WITHIN 100 METERS, THEN IMPORT EVENT”. Yet another import rule 1306 may comprise “IF LICENSE PLATE DETECTED RECEIVED AND EVENT IS WITHIN 1 KM, THEN IMPORT EVENT”. It is understood that “EVENT IS WITHIN 200 METERS”, “EVENT IS WITHIN 100 METERS”, and “EVENT IS WITHIN 1 KM” are non-limiting examples of location criteria.

However, an import rule 1306-2 may be provided in any suitable format and may comprise one or more keywords, and any suitable location criteria, without strictly incorporating such one or more keywords and/or location criteria into an “IF/THEN” statement and the like. For example, import rules 1304-2 may be provided in tables and/or in a database format that recite respective keywords and, alternatively, location criteria.

In response to the event meeting the import rule 1306-2 (e.g., a “YES” decision at the block 1410), at a block 1412, the processor 603, and/or the workflow computing device 102 initiates the second safety workflow 1300-2 associated with the second entity, the second safety workflow 1300-2 comprising a second trigger and a second responsive action executed by a second physical device associated with the second entity, the second trigger corresponding to the event.

For example, the import rule 1306-2 may comprise one or more keywords (e.g., incorporated into an “IF/THEN” statement and/or in any other suitable format), and the event meeting the import rule 1306-2 may comprise: one or more respective keywords, associated with the event, meeting one or more of the keywords of the import rule 1306-2.

Hence, for example, when an event includes one or more keywords such as “ROBBERY” and/or “ROBBERY ALARM”, and the import rule 1306-2 comprises “IF ROBBERY ALARM RECEIVED, THEN IMPORT EVENT”, the event may meet the import rule 1306-2, for example as the keyword “ROBBERY” of the event is the same as the keyword “ROBBERY” of the import rule 1306-2, and/or the keywords “ROBBERY ALARM” of the event is the same as the keywords “ROBBERY ALARM” of the import rule 1306-2.

In another example, when an event includes one or more keywords such as “LICENSE PLATE” and/or “LICENSE PLATE DETECTED”, and the import rule 1306-2 comprises “IF LICENSE PLATE DETECTED RECEIVED, THEN IMPORT EVENT”, the event may meet the import rule 1306-2, for example as the keywords “LICENSE PLATE” of the event is the same as the keywords “LICENSE PLATE” of the import rule 1306-2, and/or the keywords “LICENSE PLATE DETECTED” of the event is the same as the keywords “LICENSE PLATE DETECTED” of the import rule 1306-2.

Alternatively, the import rule 1306-2 may comprise (e.g., incorporated into an “IF/THEN” statement and/or in any other suitable format): one or more keywords; and location criteria, and the event meeting the import rule 1306-2 may comprise: one or more respective keywords, associated with the event, meeting one or more of the keywords of the import rule 1306-2; and one or more locations, associated with the event, meeting the location criteria of the import rule 1306-2.

Hence, for example, when an event includes one or more keywords such as “ROBBERY” and/or “ROBBERY ALARM”, and a location, and the import rule 1306-2 comprises “IF ROBBERY ALARM RECEIVED AND EVENT IS WITHIN 100 METERS, THEN IMPORT EVENT”, the event may meet the import rule 1306-2, for example as the keyword “ROBBERY” of the event is the same as the keyword “ROBBERY” of the import rule 1306-2 (and/or the keywords “ROBBERY ALARM” of the event is the same as the keywords “ROBBERY ALARM” of the import rule 1306-2) and when the location of the event is within 100 meters of a location associated with the import rule 1306-2, such as a location of the Building B.

In another example, when an event includes one or more keywords such as “LICENSE PLATE” and/or “LICENSE PLATE DETECTED”, and the import rule 1306-2 comprises “IF LICENSE PLATE DETECTED RECEIVED AND EVENT IS WITHIN 1 KM, THEN IMPORT EVENT,”, the event may meet the import rule 1306-2, for example as the keywords “LICENSE PLATE” of the event is the same as the keywords “LICENSE PLATE” of the import rule 1306-2 (and/or the keywords “LICENSE PLATE DETECTED” of the event is the same as the keywords “LICENSE PLATE DETECTED” of the import rule 1306-2) and when the location of the event is within 1 km of a location associated with the import rule 1306-2, such as a location of the Building B.

When a location associated with the event is an exact location (e.g., in the form of GPS coordinates, and the like), the location associated with the event may meet the location criteria of the import rule 1306-2 when the respective location associated with the import rule 1306-2 and the location associated with the event are within a distance specified by the location criteria.

Similarly, when one or more locations associated with the event is a coarse location (e.g., in the form of geofence coordinates, and the like), the one or more locations associated with the event may meet the location criteria of the import rule 1306-2 when the respective location associated with the import rule 1306-2 is within a distance of the coarse location (e.g., the geofence coordinates), the distance specified by the location criteria.

The second safety workflow 1300-2, associated with the second entity, that is initiated in response to the event meeting the import rule 1306-2 may comprise any suitable second safety workflow 1300-2 that includes a second trigger and a second responsive action executed by a second physical device associated with the second entity, and with the second trigger corresponding to the event. An example of such a second safety workflow 1300-2 is described with respect to FIG. 19. Furthermore, such physical devices may comprise one or more radios 137, 153, and the like, associated with the second entity and/or one or more transceivers (e.g., of the network interface 601) used to contact the one or more radios 137, 153 associated with the second entity, and/or one or more of the IoT devices 163, and the like, associated with the second entity, as has been previously described.

Continuing with an example of an event that includes a keyword of “ROBBERY”, the second safety workflow 1300-2 that is initiated may comprise a trigger of a “ROBBERY ALARM” and associated actions.

Continuing with an example of an event that includes keywords of “LICENSE PLATE”, and also includes the license plate number detected in the first safety workflow 1300-1, the second safety workflow 1300-2 that is initiated may comprise a trigger of a “LICENSE PLATE DETECTED” and associated actions that may include controlling pan/tilt/zoom (e.g., PTZ) of one or more cameras to search for the license plate number associated with the event.

Such second safety workflows 1300-2 may not be particular to imported events, and may be initiated as if the event were detected at the Building B and/or a location associated with the second entity. However, a given import rule 1306-2 may be associated with a particular second safety workflow 1300-2 such that, when the given import rule 1306-2 is met the associated second safety workflow 1300-2 is initiated.

Returning briefly to the blocks 1406, 1410, when a respective “NO” decision occurs (e.g., the event does not meet an export rule, or the event does not meet an import rule), the method 1400 may repeat from the block 1402. Similarly, returning briefly to the block 1412, the method 1400 may repeat from the block 1402.

The method 1400 may comprise any other suitable features.

For example, as has already been explained, the event and/or an export rule 1304 and/or an import rule 1306 may comprise respective metadata. In such examples, the event meeting the export rule 1304-1 (e.g., at the block 1406) may comprise: metadata, associated with the event, meeting one or more of keywords and respective export metadata of the export rule 1304-1. Alternatively, and/or in addition, the event meeting the import rule 1306-2 (e.g., at the block 1410) may comprise: the metadata, associated with the event, meeting one or more of respective keywords, location criteria and respective metadata of the import rule 1306-2. To distinguish between respective metadata of export rules 1304 and import rules 1306, such metadata may be respectively referred to as respective export metadata and respective import metadata.

In yet further examples, an event may comprise movement data which may be generated by the workflow computing device 102 and added to an event as metadata and/or at any other suitable portion of the event. For example, in conjunction with a trigger of the first safety workflow 1300-1 occurring, a camera associated with the first entity, such as a camera mounted to the Building A, may detect movement associated with the trigger, such as a moving vehicle associated with a robbery, and/or at which a license plate was detected, and/or a moving suspect. As such, a location, and a speed (and/or a velocity that may further specify a direction of movement) of the vehicle and/or the suspect, and the like may be determined using any suitable techniques, including, but not limited to video analysis performed by a video analysis engine 143, and the like. Using the movement data, and a given time period, such as 1 minute, 5 minutes, 15 minutes, amongst other possibilities, a distance from the event may be determined and used to determine a distance from the event that may be used in location criteria of an import rule 1306. Indeed, an import rule may specify the aforementioned given time period.

Hence, for example, when the movement data indicates that a vehicle and/or suspect is moving at 40 km/hr, and the given time period is 15 minutes, a distance of location criteria of an import rule 1306 may be set to 10 km (e.g., 0.25 hours (or 15 minutes)×40 km/hr).

In these examples, an event may include a location, and movement data of a speed, and an import rule 1306 may comprise ““IF LICENSE PLATE DETECTED RECEIVED AND EVENT IS WITHIN <DISTANCE:15 MINUTES>, THEN IMPORT EVENT,”, with the “DISTANCE” determined by multiplying the speed with the given time period (e.g., “15 MINUTES”) from the import rule 1306. In these examples, the import rule 1306 may be met when a location associated with the import rule 1306 is within the determined “DISTANCE” from the location associated with the event.

Alternatively, an event may include movement data that includes a speed and a direction of movement (e.g., a velocity), and an import rule 1306 may comprise ““IF LICENSE PLATE DETECTED RECEIVED AND EVENT IS WITHIN <DISTANCE:15 MINUTES: DIRECTION>, THEN IMPORT EVENT,”. The “DISTANCE” of such an import rule 1304 may be determined by multiplying the speed with the given time period (e.g., “15 MINUTES”) from the import rule 1306, and the “DIRECTION” may be determined from the direction of movement of the event. Hence, in these examples, the import rule 1306 may be met when a location associated with the import rule 1306 is within the determined “DISTANCE” from the location associated with the event and in the specified “DIRECTION”. For example, when the movement data indicates that a vehicle and/or suspect is moving at 40 km/hr East, and the given time period is 15 minutes, a distance of location criteria of an import rule 1306 may be set to 10 km (e.g., 0.25 hours (or 15 minutes)×40 km/hr). However, the import rule 1306 may be met when a location associated with the import rule 1306 is within 10 km East of the location associated with the event.

Hence, in such examples, an event may be associated with one or more keywords, one or more respective locations, and movement data, and an import rule 1306 may comprise: one or more respective keywords; location criteria; and a time period. In these examples, the event meeting an import rule 1306 may comprise: the one or more keywords, associated with the event, meeting one or more of the respective keywords of the import rule 1306; and a distance from the one or more respective locations associated with the event, determined from the movement data and the time period, meeting the location criteria of the import rule 1306.

In some examples, the method 1400 may further comprise the processor 603 and/or the workflow computing device 102 maintaining the log 1308 of when an event meets one or more of an export rule 1304 and an import rule 1306. For example when an export rule 1304 and/or an import rule 1306 is met, a respective indication may be stored at the log 1308. Such an indication may comprise the data of the event, the corresponding export rule 1304 and/or import rule 1306 that is met, and any metadata, amongst other possibilities.

In similar examples, the method 1400 may further comprise the processor 603 and/or the workflow computing device 102 maintaining the log 1308 of when an event does not meet one or more of an export rule 1304 and an import rule 1306. For example when an export rule 1304 and/or an import rule 1306 is not met, a respective indication may be stored at the log 1308. Such an indication may comprise the data of the event, the corresponding export rule 1304 and/or import rule 1306 that is not met, and any metadata, amongst other possibilities.

In some examples, the method 1400 may further comprise the processor 603 and/or the workflow computing device 102 receiving input from a first device associated with the first entity to one or more of define and edit an export rule 1304-1. Such a first device may comprise the first workstation 101-1 and defining and/or editing an export rule 1304-1 may occur using a dashboard and/or GUI, which may be similar to the dashboard 800, but adapted to define export rules 1304.

In some examples, the method 1400 may further comprise the processor 603 and/or the workflow computing device 102 receiving input from a second device associated with the second entity to one or more of define and edit an import rule 1306. Such a second device may comprise the second workstation 101-2 and defining and/or editing an import rule 1306-2 may occur using a dashboard and/or GUI, which may be similar to the dashboard 800, but adapted to define import rules 1306. Such a dashboard and/or GUI may be further used to associate one or more second safety workflows 1300-2 with import rules 1304-2.

In yet further examples, the method 1400 may further comprise the processor 603 and/or the workflow computing device 102 monitoring execution of at least two first safety workflows 1300-1 associated with the first entity, and a first subset of the at least two first safety workflows 1300-1 may meet an export rule 1304-1, and a second subset of the at least two first safety workflows 1300-1 may not meet an export rule 1300-1; in response to respective events of the first subset meeting one or more of the export rules 1304-1, comparing the respective events with one or more import rules 1306-2 to initiate one or more of the second safety workflows 1300-2 when the respective events meet one or more of the import rules import rules 1306-2; and in response to further respective events of the second subset not meeting any of the one or more export rules 1304-1, failing to compare the further respective events with the one or more import rules 1306-2 such that none of the one or more of second safety workflows 1300-2 are initiated. Put another way, more than one first safety workflows 1300-1 may be initiated, and associated events may be compared with the export rules 1304-1. Events that meet one or more of the export rules 1304-1 are compared to the import rules 1306-1. Events that meet one or more of the import rules 1306-1 are used to initiate one or more of the second safety workflows 1300-2. Similarly, events that do not meet any of the import rules 1306-1 are not used to initiate any of the second safety workflows 1300-2.

Attention is next directed to FIG. 15. FIG. 16, FIG. 17, FIG. 18, and FIG. 19 which depict an example of aspects of the method 1400.

With reference to FIG. 15, the dashboard 800 as previously described is depicted, and adapted for examples described in conjunction with the method 1400. It is further understood that the dashboard 800 is associated with the first workspace environment 1303-1 and may be interacted with via the first workstation 101-1.

As depicted, the dashboard 800 is adapted to include triggers 1500 of “ROBBERY ALARM”, “LICENSE PLATE DETECTED” and “BACKDOOR OPEN”, and actions 1502 of “Alert TG1”, “Alert Security Team 6” and “Control PTZ of Camera A”. The triggers 1500 and the actions 1502 have been used to configure three first safety workflows 1300-1A, 1300-1B, 1300-1C that may be executed within the first workflow environment 1303-1.

For example, a first safety workflow 1300-1A includes a trigger 1504 of “ROBBERY ALARM”, and an action 1506 of “Alert TG1”, and the first safety workflow 1300-1A may be initiated when a robbery is detected in the Building A (e.g., via a VAE 143) and/or when a physical robbery alarm device is operated in the Building A, and/or in any other suitable manner. The action 1506 “Alert TG1” is similar to the action 1002 described elsewhere in the present specification.

Another first safety workflow 1300-1B includes a trigger 1508 of “LICENSE PLATE DETECTED”, and an action 1510 of “Control PTZ of Camera A”, and the first safety workflow 1300-1B may be initiated when a license plate number from the hotlist 1302-1 is detected by an ALPR (e.g., an IoT device 143 of an associated access control system 130), and/or in any other suitable manner. The action 1510 “Control PTZ of Camera A” may result in controlling pan/tilt/zoom of the camera 143 (e.g., of an video surveillance system 130) identified by the identifier “A” to acquire an image of a vehicle having the detected license plate number, and/or to determine associated movement data. For example, an ALPR may be pointed in a particular direction, and the action 1510 may result in “Camera A” being panned and/or tilted and/or zoomed in the particular direction.

Another first safety workflow 1300-1C includes a trigger 1512 “BACKDOOR OPEN”, and an action 1514 “Alert Security Team 6”, and the first safety workflows 1300-1C may be initiated when the back door of Building A is open for example as detected by an open door detector (e.g., an IoT device 163 of an associated access control system 130). The action 1514 “Alert Security Team 6” is similar to the action 906 (and/or the action 910) described elsewhere in the present specification.

With attention directed to FIG. 16, which is substantially similar to FIG. 13, with like components having like numbers, it is understood that the workflow computing device 102 is monitoring (e.g., at the block 1402) the first safety workflows 1300-1A, 1300-1B, 1300-1C.

It is understood in this example that the export rules 1304-1 include two export rules 1304-1A, 1304-1B. In particular an export rule 1304-1A may comprise “IF ROBBERY ALARM OCCURS, THEN EXPORT EVENT” and an export rule 1304-1B may comprise “IF LICENSE PLATE DETECTED OCCURS, THEN EXPORT EVENT”.

It is understood, in this example, that the import rules 1306-1 include two import rules 1306-1A, 1306-1B. In particular an import rule 1306-1A may comprise “IF ROBBERY ALARM RECEIVED AND EVENT IS WITHIN 100 METERS, THEN IMPORT EVENT” and an import rule 1306-1B may “IF LICENSE PLATE DETECTED RECEIVED AND EVENT IS WITHIN 1 KM, THEN IMPORT EVENT”.

As depicted in FIG. 16, it is understood that the first safety workflow 1300-TA has been initiated, and an associated event 1600 is being compared (e.g., at the block 1404) with the export rules 1304-1. As depicted, the associated event 1600 comprises keywords “ROBBERY ALARM” and a location “GPS1” (e.g., of where the robbery alarm occurred) defined in GPS coordinates. While not depicted, and with brief reference to FIG. 15, the location “GPS1” may be provided to the talkgroup “TGT” in conjunction with implementing the action 1506.

In particular, it is understood that the associated event 1600 meets (e.g., a “YES” decision at the block 1406) the export rule 1304-1A of “IF ROBBERY ALARM OCCURS, THEN EXPORT EVENT”, for example as the keywords “ROBBERY ALARM” of the associated event 1600 are the same as the keywords “ROBBERY ALARM” of the export rule 1304-1A, and/or as the IF/THEN conditions are met.

As such, the associated event 1600 is compared (e.g., at the block 1408) to the import rules 1306-2 (and any import rules 1306 of any other workflow environments 1303 that the workflow computing device 102 may be implementing and/or monitoring).

In particular, it is understood that the associated event 1600 meets (e.g., a “YES” decision at the block 1410) the import rule 1306-2A of “IF ROBBERY ALARM RECEIVED AND EVENT IS WITHIN 100 METERS, THEN IMPORT EVENT”, for example as the keywords “ROBBERY ALARM” of the associated event 1600 are the same as the keywords “ROBBERY ALARM” of the import rule 1306-2A (and/or as the IF/THEN conditions are met), and as the GPS coordinates of the associated event 1600 are understood to be within 100 meters of a respective location associated with the import rule 1306-2A.

Hence, a second safety workflow 1300-2 is initiated (e.g., at the block 1412), as described in more detail with respect to FIG. 19.

While not depicted, in examples where the associated event 1600 does not meet (e.g., a “NO” decision at the block 1410) an import rule 1306-2, no second safety workflow 1300-2 is initiated.

As depicted in FIG. 17, it is understood that the first safety workflow 1300-1B has been initiated, and an associated event 1700 is being compared (e.g., at the block 1404) with the export rules 1304-1. As depicted, the associated event 1700 comprises keywords “LICENSE PLATE”, a location “GPS2” (e.g., of where the LICENSE PLATE occurred) defined in GPS coordinates, and a license plate number “ABC123” which is understood to be from the hotlist 1302-1 and is understood to comprise the license plate number detected at the trigger 1508. While not depicted, and with brief reference to FIG. 15, the license plate number “ABC123” may be provided to a video analysis engine 143 of “Camera A” in conjunction with implementing the action 1510 such that the video analysis engine 143 of “Camera A” may search for the license plate number “ABC123” in images from “Camera A”, and/or vehicle to which a license plate having the license plate number “ABC123” is attached.

In particular, it is understood that the associated event 1700 meets (e.g., a “YES” decision at the block 1406) the export rule 1304-1B of “IF LICENSE PLATE OCCURS, THEN EXPORT EVENT”, for example as the keywords “LICENSE PLATE” of the associated event 1700 are the same as the keywords “LICENSE PLATE” of the export rule 1304-1B, and/or as the IF/THEN conditions are met.

As such, the associated event 1700 is compared (e.g., at the block 1408) to the import rules 1306-2 (and any import rules 1306 of any other workflow environments 1303 that the workflow computing device 102 may be implementing and/or monitoring).

In particular, it is understood that the associated event 1700 meets (e.g., a “YES” decision at the block 1410) the import rule 1306-2B of “IF LICENSE PLATE DETECTED RECEIVED AND EVENT IS WITHIN 1 KM, THEN IMPORT EVENT”, for example as the keywords “LICENSE PLATE” of the associated event 1700 are the same as the keywords “LICENSE PLATE” of the import rule 1306-2B (and/or as the IF/THEN conditions are met), and as it is understood that the GPS coordinates of the associated event 1700 are within 1 kilometer of a respective location associated with the import rule 1306-2B.

Hence, a second safety workflow 1300-2 is initiated (e.g., at the block 1412), as described in more detail with respect to FIG. 19. In particular, the license plate number “ABC123” is understood to be used in the initiated second safety workflow 1300-2.

While not depicted, in examples where the associated event 1700 does not meet (e.g., a “NO” decision at the block 1410) an import rule 1306-2, no second safety workflow 1300-2 is initiated.

As depicted in FIG. 18, it is understood that the first safety workflow 1300-1C has been initiated, and an associated event 1800 is being compared (e.g., at the block 1404) with the export rules 1304-1. As depicted, the associated event 1800 comprises keywords “BACKDOOR OPEN”, a location “GPS3” (e.g., of where the BACKDOOR OPEN occurred) defined in GPS coordinates. While not depicted, and with brief reference to FIG. 15, the location “GPS3” may be provided to Security Team 6, in conjunction with implementing the action 1514.

In particular, it is understood that the associated event 1800 does not meet any of the export rules (e.g., a “NO” decision at the block 1406) and hence the associated event 1800 is not compared to the import rules 1306; rather, the workflow computing device 102 continues to monitor the first safety workflows 1300-1 (e.g., at the block 1402).

With reference to FIG. 19, a dashboard 1900, similar to the dashboard 800, is provided and includes a selection panel 1901 and a workspace 1902, respectively similar to the selection panel 801 and workspace 802. It is understood that the dashboard 1900 is associated with the second workspace environment 1303-2 and may be interacted with via the second workstation 101-2.

The selection panel 1901 lists available triggers 1903 and actions 1904 and includes triggers 1903 of “ROBBERY ALARM”, and “LICENSE PLATE DETECTED”, and actions 1904 of “Alert TG17”, and “Control PTZ of Camera 9X”. The triggers 1903 and actions 1904 have been used to configure two second safety workflows 1300-2A, 1300-2B, that may be executed within the second workflow environment 1303-2, and which may be initiated by events associated with first safety workflows 1300-1 as described herein.

For example a second safety workflow 1300-2A includes a trigger 1906 “ROBBERY ALARM”, and an action 1908 “Alert TG17”, and the second safety workflow 1300-2A may be initiated when a robbery is detected in the Building B and/or when a physical robbery alarm device is operated in the Building B, and/or in any other suitable manner. The action 1908 “Alert TG17” is similar to the action 1002 described elsewhere in the present specification, but occurs with respect to a talkgroup identified as “TG17”.

However, the second safety workflow 1300-2A may be associated with the import rule 1306-2A and hence may also be initiated when an event being exported, such as the event 1600, meets the import rule 1306-2A.

Indeed, as depicted, it is understood that the event 1600 has caused the second safety workflow 1300-2A to be initiated (e.g., at the block 412), and the action 1908 is being implemented. Furthermore, also as depicted, the location “GPS1” (e.g., from the event 1700) may be provided to the talkgroup “TG17”, in conjunction with implementing the action 1908. For example, the location “GPS1” is provided to the action 1908, which may cause a message to be transmitted to talkgroup “TG17” which identifies that a robbery has occurred at the location “GPS1”. In some examples, the location “GPS1” may be converted to, and/or provided as, a street address (e.g., in this example, it is understood that the workflow computing device 102 includes functionality for converting GPS coordinates to map addresses).

Another second safety workflow 1300-2B includes a trigger 1910 “LICENSE PLATE DETECTED”, and an action 1912 “Control PTZ of Camera 9X”, and the second safety workflow 1300-2B may be initiated when a license plate number from the hotlist 1302-2 is detected by an ALPR (e.g., an IoT device 143 of an associated access control system 130), and/or in any other suitable manner. The action 1912 “Control PTZ of Camera 9X” may result in controlling pan/tilt/zoom of the camera 143 (e.g., of a video surveillance system 130) identified by the identifier “9X” to acquire an image of a vehicle having the detected license plate number, and/or to determine associated movement data. For example, an ALPR may be pointed in a particular direction, and the action 1912 may result in “Camera 9X” being panned and/or tilted and/or zoomed in the particular direction.

However, the second safety workflow 1300-2B may be associated with the import rule 1306-2B and hence may also be initiated when an event being exported, such as the event 1700, meets the import rule 1306-2B.

Indeed, as depicted, it is understood that the event 1700 has caused the second safety workflow 1300-2B to be initiated (e.g., at the block 412), and the action 1912 is being implemented. Furthermore, as depicted, the location “GPS2” (e.g., from the event 1700) may be provided to the Camera “9X”, in conjunction with implementing the action 1912 so that the Camera “9X” may pan and/or tilt and/or zoom in a direction of the location “GPS2”. Similarly, as depicted, the license plate number “ABC123” (e.g., from the event 1700) may be provided to the Camera “9X”, in conjunction with implementing the action 1912 so that a video analysis engine 143 associated with the Camera “9X” may search for the license plate number “ABC123”.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, implement electronic workflows, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
monitoring, at a workflow computing device, execution of a first safety workflow associated with a first entity, the first safety workflow comprising a first trigger and a first responsive action executed by a first physical device associated with the first entity;
comparing, at the workflow computing device, an event, associated with the first trigger of the first safety workflow, with an export rule, associated with the first entity, for exporting the event to one or more second safety workflows associated with one or more second entities different from the first entity;
in response to the event of the first safety workflow meeting the export rule, comparing the event with an import rule, associated with a second entity for initiating a second safety workflow associated with the second entity, the second safety workflow based on the event; and,
in response to the event meeting the import rule, initiating the second safety workflow associated with the second entity, the second safety workflow comprising a second trigger and a second responsive action executed by a second physical device associated with the second entity, the second trigger corresponding to the event.

2. The method of claim 1, further comprising:
monitoring execution of at least two first safety workflows associated with the first entity, wherein a first subset of the at least two first safety workflows meets one or more export rules, and a second subset of the at least two first safety workflows does not meet any of the one or more export rules;
in response to respective events of the first subset meeting one or more of the export rules, comparing the respective events with one or more import rules to initiate one or more of the second safety workflows when the respective events meet one or more of the import rules; and
in response to further respective events of the second subset not meeting any of the one or more export rules, failing to compare the further respective events with the one or more import rules such that none of the one or more of second safety workflows are initiated.

3. The method of claim 1, wherein the event is associated with one or more respective keywords and one or more respective locations.

4. The method of claim 1, wherein the export rule comprises one or more keywords, and
wherein the event meeting the export rule comprises:
one or more respective keywords, associated with the event, meeting one or more of the keywords of the export rule.

5. The method of claim 1, wherein the import rule comprises: one or more keywords; and location criteria, and
wherein the event meeting the import rule comprises:
one or more respective keywords, associated with the event, meeting one or more of the keywords of the import rule; and
one or more locations, associated with the event, meeting the location criteria of the import rule.

6. The method of claim 1, wherein the event meeting the export rule comprises: metadata, associated with the event, meeting one or more of keywords and respective export metadata of the export rule, or
wherein the event meeting the import rule comprises: the metadata, associated with the event, meeting one or more of respective keywords, location criteria and respective import metadata of the import rule.

7. The method of claim 1, wherein the event is associated with one or more keywords, one or more respective locations, and movement data, and
wherein the import rule comprises: one or more respective keywords; location criteria; and a time period, and
wherein the event meeting the import rule comprises:
the one or more keywords, associated with the event, meeting one or more of the respective keywords of the import rule; and
a distance from the one or more respective locations associated with the event, determined from the movement data and the time period, meeting the location criteria of the import rule.

8. The method of claim 1, further comprising receiving input from a first device associated with the first entity to one or more of define and edit the export rule.

9. The method of claim 1, further comprising receiving input from a second device associated with the second entity to one or more of define and edit the import rule.

10. The method of claim 1, further comprising maintaining a log of when the event meets one or more of the export rule and the import rule.

11. A computing device comprising:
a processor; and
a computer-readable storage medium having stored thereon program instructions that, when executed by the processor, cause the computing device to perform a set of operations comprising:
monitoring execution of a first safety workflow associated with a first entity, the first safety workflow comprising a first trigger and a first responsive action executed by a first physical device associated with the first entity;
comparing an event, associated with the first trigger of the first safety workflow, with an export rule, associated with the first entity, for exporting the event to one or more second safety workflows associated with one or more second entities different from the first entity;
in response to the event of the first safety workflow meeting the export rule, comparing the event with an import rule, associated with a second entity for initiating a second safety workflow associated with the second entity, the second safety workflow based on the event; and,
in response to the event meeting the import rule, initiating the second safety workflow associated with the second entity, the second safety workflow comprising a second trigger and a second responsive action executed by a second physical device associated with the second entity, the second trigger corresponding to the event.

12. The computing device of claim 11, wherein the set of operations further comprise:
monitoring execution of at least two first safety workflows associated with the first entity, wherein a first subset of the at least two first safety workflows meets one or more export rules, and a second subset of the at least two first safety workflows does not meet any of the one or more export rules;
in response to respective events of the first subset meeting one or more of the export rules, comparing the respective events with one or more import rules to initiate one or more of the second safety workflows when the respective events meet one or more of the import rules; and
in response to further respective events of the second subset not meeting any of the one or more export rules, failing to compare the further respective events with the one or more import rules such that none of the one or more of second safety workflows are initiated.

13. The computing device of claim 11, wherein the event is associated with one or more respective keywords and one or more respective locations.

14. The computing device of claim 11, wherein the export rule comprises one or more keywords, and
wherein the event meeting the export rule comprises:
one or more respective keywords, associated with the event, meeting one or more of the keywords of the export rule.

15. The computing device of claim 11, wherein the import rule comprises: one or more keywords; and location criteria, and
wherein the event meeting the import rule comprises:
one or more respective keywords, associated with the event, meeting one or more of the keywords of the import rule; and
one or more locations, associated with the event, meeting the location criteria of the import rule.

16. The computing device of claim 11, wherein the event meeting the export rule comprises: metadata, associated with the event, meeting one or more of keywords and respective export metadata of the export rule, or
wherein the event meeting the import rule comprises: the metadata, associated with the event, meeting one or more of respective keywords, location criteria and respective import metadata of the import rule.

17. The computing device of claim 11, wherein the event is associated with one or more keywords, one or more respective locations, and movement data, and
wherein the import rule comprises: one or more respective keywords; location criteria; and a time period, and
wherein the event meeting the import rule comprises:
the one or more keywords, associated with the event, meeting one or more of the respective keywords of the import rule; and
a distance from the one or more respective locations associated with the event, determined from the movement data and the time period, meeting the location criteria of the import rule.

18. The computing device of claim 11, wherein the set of operations further comprises receiving input from a first device associated with the first entity to one or more of define and edit the export rule.

19. The computing device of claim 11, wherein the set of operations further comprises receiving input from a second device associated with the second entity to one or more of define and edit the import rule.

20. The computing device of claim 11, herein the set of operations further comprises maintaining a log of when the event meets one or more of the export rule and the import rule.
